(19) United States
(12) Patent Application Publication
(10) Pub. No.: US 2026/0235975 A1
(43) Pub. Date: Aug. 13, 2026

(54) IMAGE FORMING APPARATUS

(71) Applicant: CANON KABUSHIKI KAISHA, Tokyo (JP)

(72) Inventors: YU SHUHAMA, Kanagawa (JP); TOMOYA TATEISHI, Kanagawa (JP)

(21) Appl. No.: 19/534,538

(22) Filed: Feb. 9, 2026

(30) Foreign Application Priority Data
Feb. 12, 2025 (JP) 2025-020949
Feb. 12, 2025 (JP) 2025-020950

(51) Int. Cl. G03G 15/01; G03G 15/00; G03G 21/16

(52) U.S. Cl. CPC G03G 15/0173; G03G 15/50; G03G 15/80; G03G 21/1647; G03G 2221/1654; G03G 2221/1657

(57) ABSTRACT

An image forming apparatus includes a rotary including a first force receiving portion, and a main body accommodating the rotary and including a reading portion, a controller, a second force receiving portion, and a driving member. The reading portion is movable between a reading position and a retracted position. The first force receiving portion is configured to receive the driving force such that the driving force is transmitted to the rotary via the first force receiving portion in a state in which the driving member is engaged with the first force receiving portion. The second force receiving portion is configured to receive the driving force such that the driving force is transmitted to the reading portion via the second force receiving portion in a state in which the driving member is engaged with the second force receiving portion.

### BACKGROUND

### Field of the Technology

The present disclosure relates to an image forming apparatus that forms an image on a recording material.

### Description of the Related Art

Japanese Patent Application Laid-Open No. 2008-096852 discloses an image forming apparatus of a rotary development system that forms a color image by rotating a rotary including a plurality of developing rollers. Japanese Patent Application Laid-Open No. 2007-183305 discloses an image forming apparatus of a rotary development system in which four toner cartridges storing toners of different colors are attachable to and detachable from a rotary.

### SUMMARY

In an image forming apparatus of a rotary development system, a reading portion to be used in reading information from a storage portion provided in a cartridge may be provided.

According to the present disclosure, a novel image forming apparatus that advances conventional technology can be provided.

An aspect of the present disclosure provides an image forming apparatus to which a cartridge including a storage portion is to be detachably attached, the storage portion being configured to store information, the image forming apparatus including a rotary to which the cartridge is to be detachably attached, the rotary configured to rotate and including a first force receiving portion, and a main body accommodating the rotary and including a reading portion, a controller configured to read the information from the storage portion via the reading portion, a second force receiving portion connected to the reading portion, and a driving member configured to transmit a driving force, wherein the reading portion is movable between a reading position and a retracted position retracted from the reading position with respect to the rotary and configured such that the controller reads the information in a state in which the reading portion is at the reading position, wherein the first force receiving portion is configured to receive the driving force such that the driving force is transmitted to the rotary via the first force receiving portion in a state in which the driving member is engaged with the first force receiving portion, and wherein the second force receiving portion is configured to receive the driving force such that the driving force is transmitted to the reading portion via the second force receiving portion in a state in which the driving member is engaged with the second force receiving portion, such that the reading portion is moved between the reading position and the retracted position.

Another aspect of the present disclosure provides an image forming apparatus to which a cartridge including a storage portion is detachably attached, the storage portion being configured to store information, the image forming apparatus including a main body to which the cartridge is detachably attached, the main body including a drive source, a driving member configured to be moved by a driving force of the drive source, a reading portion, and a controller configured to read the information from the storage portion via the reading portion, wherein the cartridge is configured to be moved between an attached position where the cartridge is attached to the main body and a detachment position where detachment of the cartridge from the main body is allowed, by the driving force transmitted via the driving member, wherein the reading portion is configured to be moved between a reading position and a retracted position retracted from the reading position by the driving force transmitted via the driving member, and configured such that the controller reads the information in a state in which the reading portion is at the reading position, and wherein a first driving speed, that is a driving speed of the driving member in a case where the cartridge is moved from the attached position to the detachment position, is different from a second driving speed, that is a driving speed of the driving member in a case where the reading portion is moved from the retracted position to the reading position.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of an image forming apparatus according to a first embodiment.

FIG. 2A is a diagram illustrating a driving configuration of the image forming apparatus according to the first embodiment.

FIG. 2B is a control block diagram of the image forming apparatus according to the first embodiment.

FIG. 3 is a schematic view of a developing unit, a toner cartridge, and a tray according to the first embodiment.

FIGS. 4A and 4B are each a section view of the image forming apparatus according to the first embodiment.

FIG. 5 is a perspective view of a rotary body according to the first embodiment.

FIGS. 6A to 6C are each a perspective view of the image forming apparatus according to the first embodiment.

FIGS. 7A and 7B are each a section view of the image forming apparatus according to the first embodiment.

FIG. 8 is an explanatory diagram of the rotary body according to the first embodiment.

FIG. 9 is an explanatory diagram of the rotary body according to the first embodiment.

FIG. 10 is an explanatory diagram of the rotary body according to the first embodiment.

FIGS. 11A and 11B are each an explanatory diagram of elements related to the movement of the tray according to the first embodiment.

FIGS. 12A and 12B are each an explanatory diagram of elements related to the movement of the tray according to the first embodiment.

FIGS. 13A and 13B are each an explanatory diagram illustrating movement of a reading apparatus of a memory tag according to the first embodiment.

FIGS. 14A and 14B are each a perspective view of the reading apparatus according to the first embodiment.

FIGS. 15A and 15B are each an explanatory diagram illustrating a movement amount of a driving rack according to the first embodiment.

FIGS. 16A and 16B are each an explanatory diagram of a memory tag cleaning apparatus according to a modification example.

FIG. 17 is a diagram illustrating arrangement of a reading apparatus according to a second embodiment.

FIGS. 18A to 18D are each an explanatory diagram of a cancelling mechanism according to the second embodiment.

### DESCRIPTION OF THE EMBODIMENTS

Embodiments of the present disclosure will be described below with reference to drawings.

### First Embodiment

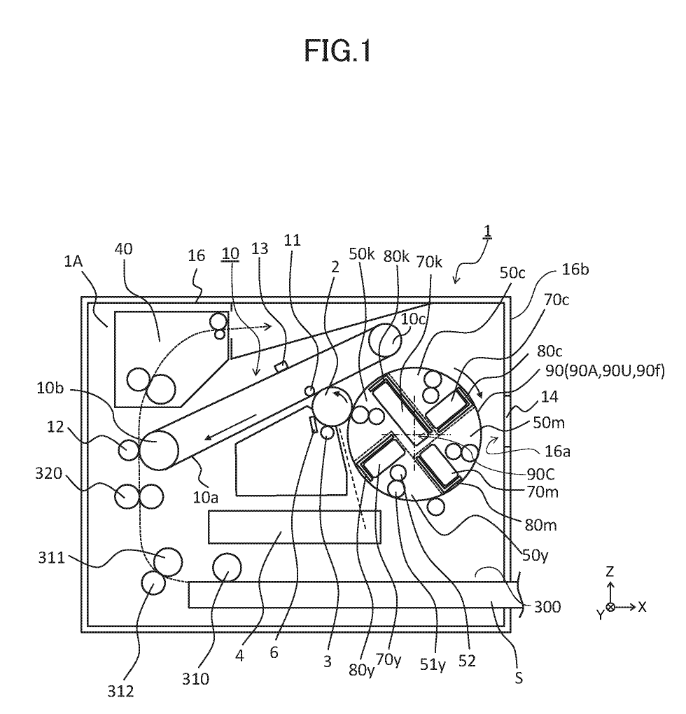

An image forming apparatus 1 according to a first embodiment will be described with reference to FIGS. 1 to 12B. In the description below and each drawing, the vertical direction in the case where the image forming apparatus 1 is disposed on a horizontal surface will be referred to as a Z direction. A direction that intersects with the Z direction and that is the direction of a rotational axis 90C of a rotary body 90 (rotational axis direction of a rotary) that will be described later will be referred to as a Y direction. A direction intersecting with both the Z direction and the Y direction will be referred to as an X direction. The X direction and the Y direction may preferably be horizontal directions. In addition, the X direction, the Y direction, and the Z direction may preferably be orthogonal to each other. In addition, the sides pointed by arrows X, Y, and Z illustrated in each diagram will be respectively referred to as +X, +Y, and +Z sides, and sides opposite thereto will be respectively referred to as -X, -Y, and -Z sides.

### Overall Configuration of Image Forming Apparatus

First, an overall configuration of the image forming apparatus 1 will be described. The image forming apparatus 1 is a laser beam printer that forms an image on a sheet S by using an electrophotographic method. Specifically, the image forming apparatus 1 is a color laser beam printer including four developing units 50y, 50m, 50c, and 50k. As the sheet S serving as a recording material (recording medium), various sheet materials of different sizes and different materials can be used. Examples of the various sheet materials include paper sheets such as plain paper sheets and cardboards, plastic films, cloths, surface-treated sheet materials such as coated paper sheets, and sheet materials of irregular shapes such as envelopes and index paper sheets.

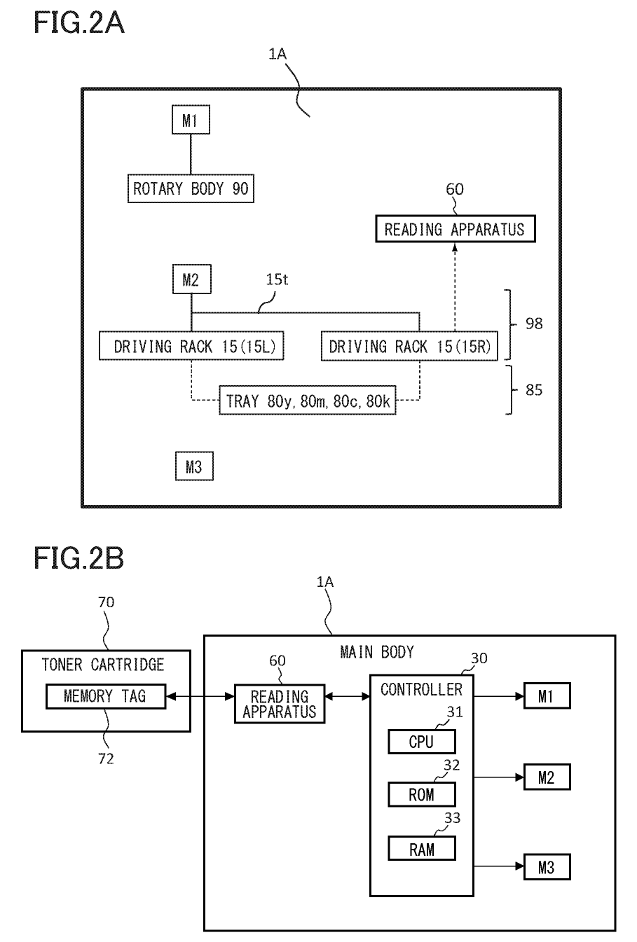

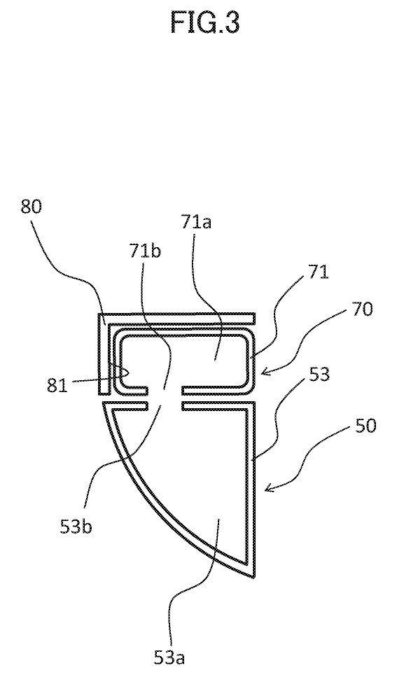

A schematic configuration of the image forming apparatus 1 and an image forming operation will be described with reference to FIGS. 1, 2A, 2B, and 3. FIG. 1 is a schematic diagram illustrating a sectional configuration of the image forming apparatus 1. FIG. 2A is a diagram for describing drive sources of the image forming apparatus 1. FIG. 2B is a block diagram for describing the control of the image forming apparatus 1. FIG. 3 is a concept diagram illustrating elements for supplying toner from a toner cartridge 70 to a developing unit 50.

As illustrated in FIG. 1, the image forming apparatus 1 includes an image forming apparatus main body (hereinafter referred to as a main body 1A), and toner cartridges 70y, 70m, 70c, and 70k that are attachable to and detachable from the main body 1A. The main body 1A of the present embodiment is a part of the image forming apparatus 1 excluding the toner cartridges 70y, 70m, 70c, and 70k.

The main body 1A of the image forming apparatus 1 includes an electrophotographic photosensitive member 2 (hereinafter referred to as a photosensitive drum 2) having a drum shape (cylindrical shape). The photosensitive member 2 serves as an image bearing member that bears an electrostatic latent image. A charging roller 3, a scanner 4 serving as an exposing device, and a cleaning unit 6 are disposed around the photosensitive drum 2.

The charging roller 3 is an example of a charging means or a charging unit for uniformly charging the photosensitive drum 2. The scanner 4 is an example of an exposing means or an exposing unit that exposes the photosensitive drum 2 by irradiating the photosensitive drum 2 with laser light in accordance with image information. By irradiating the photosensitive drum 2 with the laser light after charging, an electrostatic latent image is formed on the surface of the photosensitive drum 2. The cleaning unit 6 is an example of a cleaning means or a cleaning portion that removes toner remaining on the surface of the photosensitive drum 2.

Further, the main body 1A includes a sheet storage portion 300, a pickup roller 310, a feed roller 311, a separation roller 312, a conveyance roller pair 320, a secondary transfer roller 12, a fixing device 40, and an intermediate transfer unit 10. The pickup roller 310 is an example of a feeding means or a feeding unit that feeds the sheet S. The feed roller 311 and the separation roller 312 are an example of a separation conveyance unit that conveys sheets S while separating the sheets S from each other by frictional force. The secondary transfer roller 12 is an example of a transfer means or a transfer unit that transfers an image from an intermediate transfer belt 10a onto the sheet S.

The intermediate transfer unit 10 includes an intermediate transfer belt 10a, a belt driving roller 10b, a tension roller 10c, a cleaning device 13, and a primary transfer roller 11. The intermediate transfer belt 10a is an example of an intermediate transfer member that bears an image transferred from the photosensitive drum 2 through primary transfer and conveys the image so as to transfer the image onto the sheet S through secondary transfer. The intermediate transfer belt 10a is stretched over the belt driving roller 10b and the tension roller 10c. The belt driving roller 10b is a driving member that is rotationally driven by a drive source to convey the intermediate transfer belt 10a.

In addition, the main body 1A includes a rotary body 90, which serves as a rotary, rotary member, or developing device, including the developing units 50y, 50m, 50c, and 50k. As will be described later, trays 80y, 80m, 80c, and 80k, which serve as support members, are attached to the rotary body 90 in the present embodiment. Toner cartridges 70y, 70m, 70c, and 70k are detachably attached to the trays 80y, 80m, 80c, and 80k.

In the description below, a plurality of members having similar functions can be distinguished by numbers given thereto. For example, one of the toner cartridges 70y, 70m, 70c, and 70k may be referred to as a first toner cartridge, one of the remaining three may be referred to as a second toner cartridge, one of the remaining two may be referred to as a third toner cartridge, and the last one may be referred to as a fourth toner cartridge. Similarly, one of the trays 80y, 80m, 80c, and 80k may be referred to as a first tray, one of the remaining three may be referred to as a second tray, one of the remaining two may be referred to as a third tray, and the last one may be referred to as a fourth tray. That is, one of the trays 80y to 80k is an example of a first support member, another one of the trays 80y to 80kis an example of a second support member, yet another one of the trays 80y to 80k is an example of a third support member, and the last one of the trays 80y to 80k is an example of a fourth support member. This numbering is merely used for the sake of convenience of description, and can be interchanged appropriately in principle.

The developing units 50y, 50m, 50c, and 50k serving as first to fourth developing units are examples of developing means or developing portions that each develop (visualize) an electrostatic latent image formed on the photosensitive drum 2 into a toner image by using toner of a corresponding color. The developing units 50y, 50m, 50c, and 50k each develop the electrostatic latent image formed on the photosensitive drum 2 by using corresponding one of yellow toner, magenta toner, cyan toner, and black toner. The developing units 50y, 50m, 50c, and 50k may be arranged in an order different from the order illustrated in FIG. 1.

The developing unit 50y includes a developing roller 51y, a supply roller 52, and a developing blade. The developing roller 51y is a developer bearing member that rotates while bearing toner serving as developer, and supplies the toner to the photosensitive drum 2. The supply roller 52 is a supply member that is disposed in contact with the developing roller 51y and supplies toner to the developing roller 51y. The developing blade is a regulation member that regulates the thickness of a toner layer borne on the developing roller 51y. The other developing units 50m, 50c, and 50k respectively include developing rollers 51m, 51c, and 51k, supply rollers 52, and developing blades that are configured in a similar manner.

The toner cartridges 70y, 70m, 70c, and 70k corresponding to the developing units 50y, 50m, 50c, and 50k are attached to the rotary body 90. The toner cartridges 70y, 70m, 70c, and 70k respectively store therein yellow toner, magenta toner, cyan toner, and black toner to be supplied to the developing units 50y, 50m, 50c, and 50k. One of the toners of four colors may be referred to as first toner, one of the toners of remaining three colors may be referred to as second toner, one of the toners of remaining two colors may be referred to as third toner, and the toner of the last remaining color may be referred to as fourth toner. For example, the black toner may be referred to as an example of first toner, and the magenta toner may be referred to as an example of second toner. This numbering is merely used for the sake of convenience of description, and can be interchanged appropriately in principle.

Here, the rotary body 90 includes a rotary frame 90f supporting the developing units 50y, 50m, 50c, and 50k. The developing units 50y, 50m, 50c, and 50k are supported by the rotary frame 90f that is a rotary support member that is rotatable.

In addition, the trays 80y, 80m, 80c, and 80k are attached to the rotary body 90. The rotary body 90 and the trays 80y, 80m, 80c, and 80k as a combination can be referred to as a rotary unit 90U. In other words, the rotary unit 90U includes the rotary body 90 and the trays 80y, 80m, 80c, and 80k.

The toner cartridges 70y to 70k are detachably held by the trays 80y to 80k. As will be described later, the trays 80y to 80k are supported so as to be slidable to the outside of the rotary body 90. The rotary unit 90U and the toner cartridges 70y, 70m, 70c, and 70k as combined can be referred to as a rotary assembly 90A. In other words, the rotary assembly 90A includes the rotary unit 90U and the toner cartridges 70y, 70m, 70c, and 70k.

As will be described later, the rotary body 90 is rotatable about a rotational axis (rotational center) 90C. The rotational axis 90C coincides with a rotational axis of the rotary frame 90f, that of the rotary unit 90U, and that of the rotary assembly 90A. In addition, the rotational axis 90C is substantially parallel to the rotational axis (rotational center) of the photosensitive drum 2.

The rotary body 90 rotates about the rotational axis 90C, and thus can take developing postures such that any one of the developing rollers 51y, 51m, 51c, and 51k faces the photosensitive drum 2. A posture in which the developing roller 51y faces the photosensitive drum 2 will be referred to as a yellow developing posture. A posture in which the developing roller 51m faces the photosensitive drum 2 will be referred to as a magenta developing posture. A posture in which the developing roller 51c faces the photosensitive drum 2 will be referred to as a cyan developing posture. A posture in which the developing roller 51k faces the photosensitive drum 2 will be referred to as a black developing posture. That is, the rotary body 90 can rotate about the rotational axis 90C such that the positions of the developing rollers 51y, 51m, 51c, and 51k change with respect to the photosensitive drum 2. The black developing posture is an example of a first developing posture in which the first developing roller (e.g., developing roller 51k) faces the photosensitive drum 2. The other developing postures are examples of a second developing posture in which a second developing roller (e.g., one of the developing rollers 51y to 51c) faces the photosensitive drum 2. The yellow/magenta/cyan/black developing postures can be referred to as first to fourth developing postures. This numbering is merely used for the sake of convenience of description, and can be interchanged appropriately in principle.

As illustrated in FIGS. 2A and 2B, the main body 1A includes a controller 30, motors M1, M2, and M3 serving as drive sources, and a reading apparatus 60. The controller 30 is a control means that controls the operation of the image forming apparatus 1 in accordance with a program. The controller 30 includes a read-only memory (ROM) 32 that stores a program, a central processing unit (CPU) 31 that reads and executes the program from the ROM 32, and a random access memory (RAM) 33 that provides a work area for execution of the program. The controller 30 is configured to read information from a memory tag 72 provided on the toner cartridge 70 via the reading apparatus 60. The reading apparatus 60 will be described later. The CPU 31 is an example of an arithmetic processing unit, and the ROM 32 and the RAM 33 are each an example of a storage device. The number of the CPU 31, the number of the ROM 32, and the number of the RAM 33 in the controller 30 may be one or more of each.

The motor M1 supplies a driving force for rotating the rotary body 90 about the rotational axis 90C. In other words, the motor M1 rotates the rotary assembly 90A and the rotary unit 90U about the rotational axis 90C.

In addition, the main body 1A includes a driving device 98 including the motor M2 and a transmission device. The transmission device includes driving racks 15L and 15R, serving as driving gears, and a transmission portion 15t that will be described later. The driving force of the motor M2 is transmitted to the driving racks 15L and 15R by the transmission portion 15t. In other words, the motor M2 is configured to drive the driving racks 15L and 15R, and moves the trays 80y, 80m, 80c, and 80k with respect to the rotary body 90 via the driving racks 15L and 15R.

The motor M3 drives members that are not driven by the motors M1 and M2. For example, the motor M3 drives the photosensitive drum 2, the developing units 50y, 50m, 50c, and 50k, the pickup roller 310, the feed roller 311, the conveyance roller pair 320, the secondary transfer roller 12, the belt driving roller 10b, and the fixing device 40.

To be noted, the members driven by the motors M1, M2, and M3 can be appropriately changed. In addition, the roles of two or three of the motors M1, M2, and M3 can be concentrated in one motor. In addition, a drive source other than the motors M1, M2, and M3 may be added.

Here, the suffices y, m, c, and k given to the developing units 50y, 50m, 50c, and 50k, the toner cartridges 70y, 70m, 70c, and 70k, the trays 80y, 80m, 80c, and 80k, and the like indicate the colors of toner. The developing units 50y, 50m, 50c, and 50k basically have the same configuration and function. The toner cartridges 70y, 70m, 70c, and 70k basically have the same configuration and function. In addition, the trays 80y, 80m, 80c, and 80k basically have the same configuration and function. Therefore, in the case where these do not need to be distinguished, the suffices y, m, c, and k will be omitted, and arbitrarily selected one of the four units, four cartridges, and four trays will be described.

As illustrated in FIG. 3, the toner cartridge 70 includes a toner frame 71. The toner frame 71 includes a toner storage portion 71a that stores toner, and a discharge opening 71b communicating with the toner storage portion 71a.

The developing unit 50 includes a developing frame 53 serving as a storage frame. The developing frame 53 includes a developing-side storage portion 53a and an inlet opening 53b communicating with the developing-side storage portion (toner supply chamber) 53a. To be noted, as described above, although the developing unit 50 includes the developing roller 51, the supply roller 52, and the like, illustration of these members is omitted in FIG. 3.

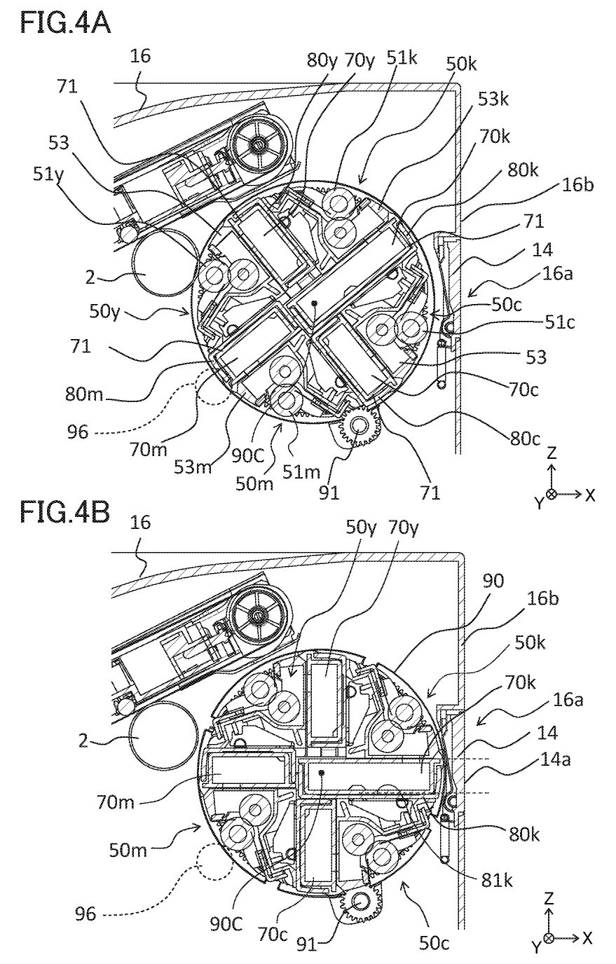

The developing roller 51k included in the developing unit 50k is an example of a first developing roller. The developing roller 51m included in the developing unit 50m is an example of a second developing roller. A developing frame 53k of the developing unit 50kincluding the developing-side storage portion 53a illustrated in FIG. 4A is an example of a first storage frame including a first storage portion. A developing frame 53m of the developing unit 50mincluding the developing-side storage portion 53a illustrated in FIG. 4A is an example of a second storage frame including a second storage portion. The rotary body 90 is an example of a rotary that is rotatable and includes a first developing roller, a second developing roller, a first storage frame including a first storage portion, and a second storage frame including a second storage portion. In the present embodiment, the rotary body 90 includes first to fourth developing rollers and first to fourth storage frames.

As will be described later, the toner cartridge 70 is movable to an attached position and a retracted position where the toner cartridge 70 is retracted from the attached position, with respect to the developing frame 53. The retracted position can be referred to as a detachment position at which detachment of the toner cartridge 70 from the main body 1A is permitted. In a state in which the toner cartridge 70 is at the attached position with respect to the developing frame 53, the discharge opening 71b faces the inlet opening 53b. That is, the toner storage portion 71a of the toner cartridge 70 and the developing-side storage portion 53a of the developing unit 50 communicate with each other via the discharge opening 71b and the inlet opening 53b. When toner is supplied from the toner cartridge 70 to the developing unit 50, at least part of the inlet opening 53b is positioned below at least part of the discharge opening 71b.

Then, toner stored in the toner storage portion 71a is discharged through the discharge opening 71b, and the toner discharged through the discharge opening 71b is stored in the developing-side storage portion 53a through the inlet opening 53b. The toner stored in the developing-side storage portion 53a is supplied to the developing roller 51 by the supply roller 52. The toner stored in the toner storage portion 71a is supplied to the developing roller 51 through such a path.

The toner cartridge 70 may preferably include an unillustrated sealing member (first sealing member) that covers the discharge opening 71b. In addition, the developing unit 50 may preferably include an unillustrated sealing member (second sealing member) that covers the inlet opening 53b.

In a state in which the toner cartridge 70 is not attached to the developing unit 50, each of the discharge opening 71b and the inlet opening 53b may preferably be covered by a sealing member such that leakage of toner through the discharge opening 71b and the inlet opening 53b is suppressed.

### Image Forming Operation

An image forming operation in the present embodiment will be described. First, the photosensitive drum 2 is rotated in an arrow direction (counterclockwise direction) in FIG. 1 in synchronization with the rotation of the intermediate transfer belt 10a. Further, the surface of the photosensitive drum 2 is uniformly charged by the charging roller 3.

In the case of forming a color image on the sheet S, the rotary body 90 rotates in an arrow direction (clockwise direction) in FIG. 1 while supporting the developing units 50y, 50m, 50c, and 50k. Then, an electrophotographic process is repeatedly performed while moving the developing rollers 51y, 51m, 51c, and 51k to a developing position one by one.

First, the scanner 4 emits laser light based on image data corresponding to a yellow image, and thus forms an electrostatic latent image corresponding to the yellow image on the surface of the photosensitive drum 2. In parallel with the formation of this electrostatic latent image, the motor M1 rotates the rotary body 90, and the rotary body 90 takes the yellow developing posture. When the rotary body 90 is in the yellow developing posture, the developing roller 51y is in the developing position, and the electrostatic latent image formed on the photosensitive drum 2 is developed with yellow toner.

Here, in the present embodiment, the developing rollers 51y, 51m, 51c, and 51k are each an elastic roller formed by covering a metal shaft with rubber. At the developing position, the developing rollers 51y, 51m, 51c, and 51k each develop the electrostatic latent image in a state of being in contact with the photosensitive drum 2. That is, a contact development system is employed for the image forming apparatus 1 of the present embodiment. However, at the developing position, each of the developing rollers 51y, 51m, 51c, and 51k may develop the electrostatic latent image with a gap between the developing roller and the photosensitive drum 2. That is, a non-contact development system may be employed for the image forming apparatus 1.

After the yellow toner image is developed, the yellow toner image on the photosensitive drum 2 is transferred onto the intermediate transfer belt 10a through primary transfer by the primary transfer roller 11 disposed on the inner peripheral side of the intermediate transfer belt 10a.

After this, toner images of respective colors are formed by rotating the rotary body 90 and thus sequentially moving the developing rollers 51m, 51c, and 51k to the developing position. That is, after the yellow toner image is formed on the intermediate transfer belt 10a, the rotary body 90 takes a magenta developing posture, and a magenta toner image is formed on the intermediate transfer belt 10a. After the magenta toner image is formed on the intermediate transfer belt 10a, the rotary body 90 takes a cyan developing posture, and a cyan toner image is formed on the intermediate transfer belt 10a. After the cyan toner image is formed on the intermediate transfer belt 10a, the rotary body 90 takes a black developing posture, and a black toner image is formed on the intermediate transfer belt 10a. After the black toner image is formed on the intermediate transfer belt 10a, the rotary body 90 rotates about the rotational axis 90C in an arrow direction (clockwise direction) illustrated in FIG. 1, and returns to the yellow developing posture. To be noted, the color of the image to be formed first on the intermediate transfer belt 10a can be arbitrarily selected, and for example, the black toner image may be formed first.

Then, primary transfer is repeated so as to superimpose the toner images of four colors on each other on the intermediate transfer belt 10a, and thus a color image is formed on the intermediate transfer belt 10a. To be noted, before the color image is formed on the intermediate transfer belt 10a, the secondary transfer roller 12 and the cleaning device 13 are not in contact with the intermediate transfer belt 10a.

Meanwhile, the sheet S is fed by the pickup roller 310 from the sheet storage portion 300 provided in a lower portion of the main body 1A. The sheet S is conveyed to the conveyance roller pair 320 in a state in which one sheet S is separated from a stack of sheets S by the feed roller 311 and the separation roller 312. The conveyance roller pair 320 delivers out the fed sheet S to a transfer portion (secondary transfer portion) that is a nip portion between the intermediate transfer belt 10a and the secondary transfer roller 12. The color image on the intermediate transfer belt 10a is transferred onto the surface of the conveyed sheet S through secondary transfer.

The sheet S onto which a color image has been transferred is conveyed to the fixing device 40. In the fixing device 40, the sheet S is heated and pressurized, and thus the image is fixed to the sheet S. The sheet S having passed the fixing device 40 is discharged to the outside of the image forming apparatus 1 as a product.

In contrast, in the case of forming a black-and-white image (monochrome image) on the sheet S, the rotary body 90 takes the black developing posture. In this state, an electrostatic latent image is formed on the surface of the photosensitive drum 2 by charging and exposing the photosensitive drum 2, and then the electrostatic latent image is developed with black toner by the developing roller 51k positioned at the developing position. The black toner image is transferred onto the intermediate transfer belt 10a through primary transfer, and then the toner image is transferred onto the sheet S through secondary transfer. Steps after this are similar to the case of a color image.

### Rotary Configuration

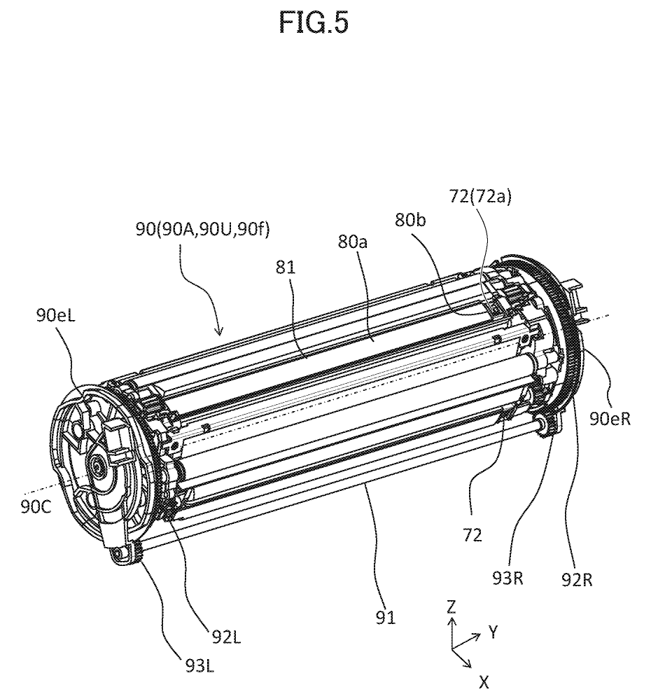

The configuration of the rotary body 90 will be described with reference to FIGS. 1, 4A, 4B, and 5. FIGS. 4A and 4B are each a section view of the rotary body 90 of the image forming apparatus 1 and the surroundings thereof. To be noted, FIGS. 4A and 4B are each a section view taken along a virtual plane orthogonal to the rotational axis 90C of the rotary body 90. FIG. 5 is a perspective view of the rotary body 90.

As has been described, the toner cartridges 70yto 70kare attachable to and detachable from the rotary body 90. In the case where toner in the toner cartridges 70yto 70khas run out, the user can replenish the image forming apparatus 1 with toner by replacing the toner cartridges 70yto 70k.

As illustrated in FIG. 1, the main body 1A includes a frame 16 accommodating the rotary body 90. The frame 16 is a body frame of the image forming apparatus 1 of the present embodiment. The frame 16 is a casing or skeleton of the main body 1A constituted by a frame and exterior members, and has an approximately rectangular parallelepiped shape.

The frame 16 has an opening 16a. More specifically, the frame 16 has a side surface 16b extending in a direction intersecting with the horizontal direction. The side surface 16b constitutes at least part of the exterior surface of the main body 1A on the +X side. The opening 16a is provided in the side surface 16b. The side surface 16b is a side surface disposed on the downstream side of the discharge port in a discharge direction in which the sheet S on which an image has been formed is discharged from the main body 1A through the discharge port. From the side surface 16b side of the image forming apparatus 1, the user can access the sheet storage portion 300 to replenish the sheet storage portion 300 with sheets S, and can obtain the sheet S discharged through the discharge port. Therefore, the side surface 16b can be referred to as the front surface of the main body 1A.

The toner cartridges 70y, 70m, 70c, and 70k are attachable to and detachable from the rotary body 90 through the opening 16a. That is, the toner cartridge 70k can be referred to as an example of a first toner cartridge that stores toner to be supplied to the first developing roller (developing roller 51k) and that is attachable to and detachable from the rotary (rotary body 90) through the opening 16a of the frame 16 of the main body 1A. The toner cartridge 70mcan be referred to as an example of a second toner cartridge that stores toner to be supplied to the second developing roller (developing roller 51m) and that is attachable to and detachable from the rotary (rotary body 90) through the opening 16a of the frame 16 of the main body 1A.

In the present embodiment, the toner cartridges 70y, 70m, 70c, and 70k are attached to and detached from the rotary body 90 through the opening 16a in the state of being supported by the trays 80y to 80k. In other words, the user can attach and detach the toner cartridges 70yto 70kto and from the rotary body 90 via the trays 80y to 80k.

The opening 16a is disposed in the side surface 16b of the frame 16. In the present embodiment, the side surface 16b is a surface approximately parallel to the rotational axis 90C of the rotary body 90. Therefore, in the case of replacing the toner cartridge 70, the toner cartridge 70 passes through the opening 16a in a direction intersecting with the rotational axis 90C (the direction may preferably be a direction orthogonal to the rotational axis 90C).

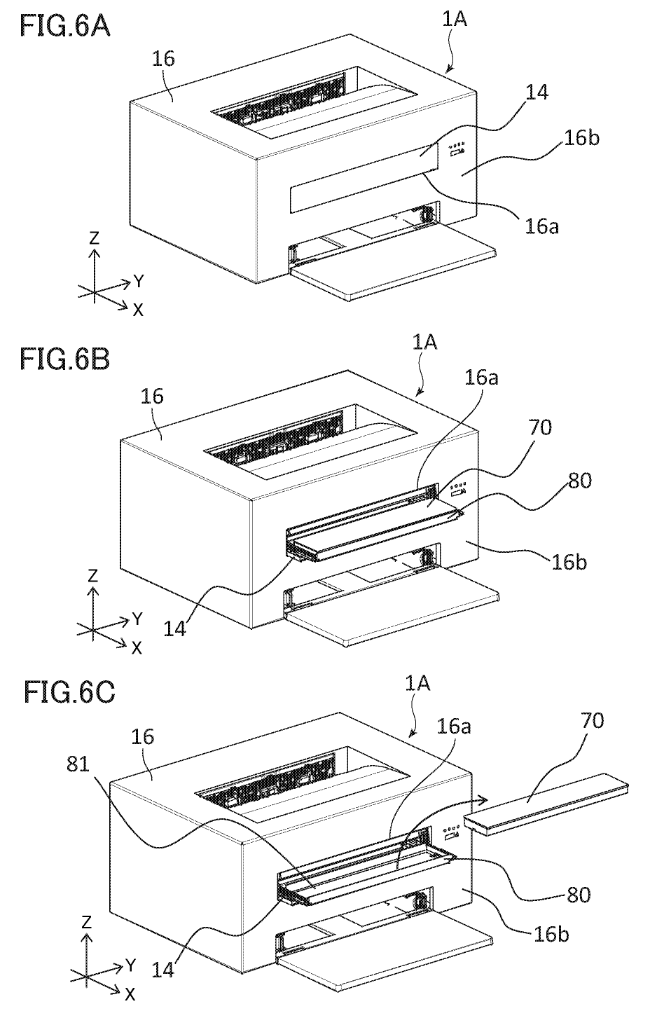

The image forming apparatus 1 includes a door 14 that covers the opening 16a of the frame 16. The door 14 is an opening/closing member movable to a closed position illustrated in FIG. 6A where the door 14 covers the opening 16a and an open position illustrated in FIGS. 6B and 6C where the opening 16a is exposed.

As described above, in the present embodiment, the toner cartridge 70 is configured to be attachable to and detachable from the rotary body 90 via the tray 80. Therefore, the toner cartridge 70 can be stably attached to and detached from the rotary body 90.

More specifically, the user can replace the toner cartridge 70 by an operation of attaching and detaching the toner cartridge 70 to and from the tray 80 configured to be movable with respect to the rotary body 90 (that is, with respect to the main body 1A). In the case of a configuration in which the toner cartridge is replaced by the user directly inserting and removing the toner cartridge in and from the main body, the user is required to insert the toner cartridge to a predetermined attached position in the main body. In the present embodiment, the tray 80 is capable of moving such that the toner cartridge 70 moves to the attached position in a state in which the tray 80 is supporting the toner cartridge 70. Therefore, the user can replace the toner cartridge 70 by a simple operation of placing the toner cartridge 70 on the tray 80, and thus the operability is improved.

To be noted, the toner cartridge 70 has a thin elongated shape with the Y direction parallel to the rotational axis 90C of the rotary body 90 as a longitudinal direction. That is, the dimension of the toner cartridge 70 in the longitudinal direction is larger than its height and width in a cross-section orthogonal to the longitudinal direction. In the case of using the toner cartridge 70 having a thin elongated shape as described above, the toner cartridge 70 can be passed through the opening 16a in a short movement distance by providing the opening 16a in the side surface 16b of the frame 16 that is approximately parallel to the longitudinal direction (Y direction) of the toner cartridge 70. The replacement of the toner cartridge 70 becomes easier than, for example, a case where the toner cartridge 70 is inserted or removed through an opening provided in a side surface on one side (+Y side or -Y side) of the frame 16 in the longitudinal direction of the toner cartridge 70.

The rotary body 90 rotates about the rotational axis 90C, and thus can take a replacement posture in which detachment of one of the toner cartridges 70yto 70kfrom the rotary body 90 is allowed. A posture in which the detachment of the toner cartridge 70y is allowed will be referred to as a yellow replacement posture. A posture in which the detachment of the toner cartridge 70m is allowed will be referred to as a magenta replacement posture. A posture in which the detachment of the toner cartridge 70c is allowed will be referred to as a cyan replacement posture. A posture in which the detachment of the toner cartridge 70k is allowed will be referred to as a black replacement posture. The black replacement posture is an example of a first replacement posture in which detachment of a first toner cartridge from the rotary body 90 is allowed. The yellow/magenta/cyan replacement postures are examples of a second replacement posture in which detachment of a second toner cartridge from the rotary body 90 is allowed. The yellow/magenta/cyan/black replacement postures can be referred to as first to fourth replacement postures. This numbering is merely used for the sake of convenience of description, and can be interchanged appropriately in principle.

The rotary body 90 rotates about the rotational axis 90C in a clockwise direction of FIG. 1, and can sequentially take the yellow/magenta/cyan/black replacement postures. In the present embodiment, the rotary body 90 rotates about the rotational axis 90C in the clockwise direction of FIG. 1, and thus the developing posture and the replacement posture can be switched alternately. For example, in FIG. 1, the rotary body 90 is in the black developing posture. By rotating the rotary body 90 in the clockwise direction from this state, the posture of the rotary body 90 can be switched in the order of the cyan replacement posture, the yellow developing posture, the black replacement posture, the magenta developing posture, the yellow replacement posture, the cyan developing posture, and the magenta replacement posture. By rotating the rotary body 90 in the clockwise direction from the magenta replacement posture, the rotary body 90 returns to the black developing posture. That is, the rotary body 90 can rotate more than once (360°) in the clockwise direction.

FIG. 4A illustrates a cross-section of the rotary body 90 in a developing posture (specifically, the yellow developing posture). FIG. 4B illustrates a cross-section of the rotary body 90 in a replacement posture (specifically, the black replacement posture).

As illustrated in FIGS. 4A and 4B, the four trays 80yto 80kare attached to the rotary body 90. The trays 80y to 80krespectively hold the toner cartridges 70y to 70k. In FIGS. 4A and 4B, the trays 80y to 80kare accommodated in the rotary body 90, and this state can be referred to as a state in which the toner cartridges 70y to 70k are attached to the developing units 50y, 50m, 50c, and 50k.

As described above, the toner cartridge 70 is movable to an attached position and a retracted position where the toner cartridge 70 is retracted from the attached position, with respect to the developing frame 53 of the developing unit 50. That is, the first toner cartridge (toner cartridge 70k) is movable to a first attached position and a first retracted position with respect to a first storage frame (developing frame 53k). The second toner cartridge (toner cartridge 70m) is movable to a second attached position and a second retracted position with respect to a second storage frame (developing frame 53m).

In a state in which the toner cartridge 70 is at the attached position with respect to the developing frame 53, the discharge opening 71b and the inlet opening 53b face each other as illustrated in FIG. 3. The toner cartridge 70 is configured to supply toner to the developing-side storage portion 53a through the inlet opening 53b (opening of the storage frame) in this state.

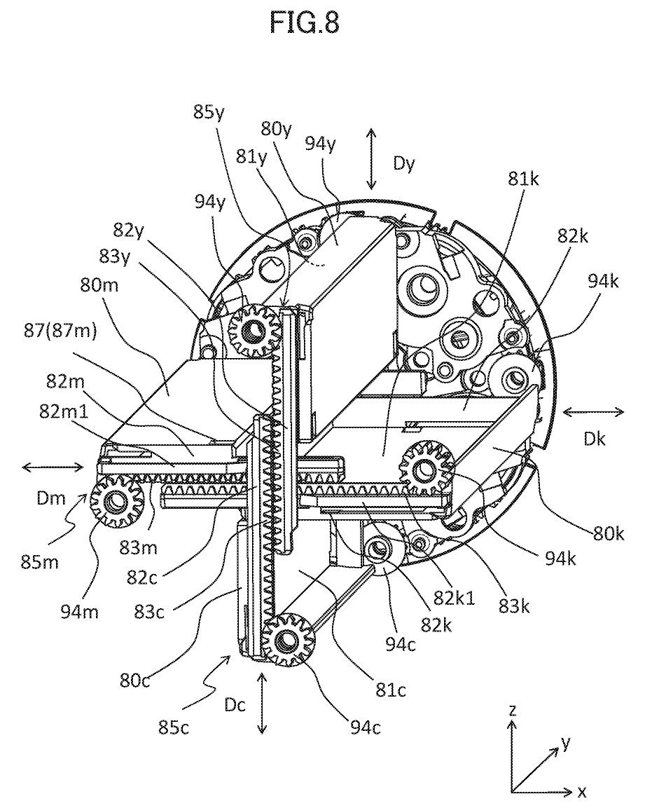

The main body 1A includes a moving device 85 configured to move the toner cartridge 70 from the attached position to the retracted position with respect to the rotary body 90 (more specifically, with respect to the developing frame 53 of the developing unit 50). The moving device 85 will be described below with reference to FIG. 8 and the like. In the present embodiment, a plurality of moving devices 85yto 85kcorresponding to the plurality of toner cartridges 70y to 70kare disposed in the rotary body 90. The trays 80y to 80kcan be referred to as part of the moving devices 85y to 85k.

In the present embodiment, the toner cartridge 70k storing the black toner is larger in size than the toner cartridges 70y to 70cstoring yellow toner, magenta toner, and cyan toner, and is capable of storing more toner. In other words, the first toner cartridge is capable of storing a first amount of toner, the second toner cartridge is capable of storing a second amount of toner, and the first amount is larger than the second amount.

Specifically, the length of the black toner cartridge 70k in a first radial direction with respect to the rotational axis 90C of the rotary body 90 is larger than the length of the magenta toner cartridge 70m in a second radial direction. Here, the first radial direction is a rotational radius direction (radial direction of a virtual circle centered on the rotational axis 90C) of the rotary body 90, and is a direction in which the toner cartridge 70k extends with respect to the rotational axis 90C as viewed in the direction of the rotational axis 90C. The second radial direction is a rotational radius direction of the rotary body 90, and is a direction in which the toner cartridge 70m extends with respect to the rotational axis 90C as viewed in the direction of the rotational axis 90C. Similarly, the length of the black toner cartridge 70k in the first radial direction is larger than the lengths of the other toner cartridges 70y and 70c in the radial directions corresponding to the toner cartridges 70y and 70c.

Accordingly, the tray 80k holding the black toner cartridge 70k is larger in size than the trays 80yto 80cholding the other toner cartridges 70y, 70m, and 70c. That is, the four toner cartridges 70y to 70k and the trays 80yto 80khaving different sizes are disposed in the rotary body 90. In other words, the toner cartridge 70k serving as an example of a first toner cartridge and the toner cartridge 70y serving as an example of a second toner cartridge smaller than the first toner cartridge are attachable to and detachable from the rotary body 90. In accordance with this, the tray 80kserving as an example of a first support member that supports the first toner cartridge and the tray 80y serving as an example of a second support member smaller than the first support member are provided in the rotary body 90. In addition, the toner cartridges 70mand 70c serving as examples of a third toner cartridge and a fourth toner cartridge that are smaller in size than the first toner cartridge are attachable to and detachable from the rotary body 90. In accordance with this, the trays 80mand 80cserving as examples of a third support member and a fourth support member that are smaller in size than the first support member are provided in the rotary body 90.

Here, rotational driving of the rotary body 90 will be described with reference to FIG. 5. As illustrated in FIG. 5, disk gears 92L and 92R are formed on respective end portions of the rotary body 90. In addition, rotary driving gears 93L and 93R are formed on respective end portions of a swing shaft 91 in a manner capable of transmitting a driving force. Here, the driving force of the motor M1 is transmitted to the rotary driving gear 93R via a drive transmission mechanism. Next, the driving force is transmitted to the disk gears 92L and 92R via the rotary driving gears 93L and 93R, and thus the rotary body 90 is rotationally driven. The rotary body 90 rotates about the rotational axis 90C in the clockwise direction in FIG. 1.

In addition, the rotary body 90 is supported so as to be swingable about the swing shaft 91. The rotary body 90 is urged in a counterclockwise direction in FIGS. 4A and 4B about the swing shaft 91 by an unillustrated urging member. This direction can be referred to as a direction in which the developing rollers 51y to 51k each approach the photosensitive drum 2. As a result of this, one of the developing rollers 51y to 51k is in contact with the photosensitive drum 2 in a state in which the rotary body 90 is in a developing posture.

Meanwhile, as illustrated in FIG. 5, rotary cams 90eL and 90eR are provided on respective end portions of the rotary body 90. When the rotary body 90 rotates about the rotational axis 90C in a clockwise direction in FIGS. 4A and 4B, the rotary cams 90eL and 90eR come into contact with a roller 96 supported by the frame 16 illustrated in FIGS. 4A and 4B. Then, the rotary body 90 moves in the clockwise direction in FIGS. 4A and 4B about the swing shaft 91. This direction can be referred to as a direction in which the developing rollers 51y to 51keach move away from the photosensitive drum 2. In addition, this direction can be referred to as a direction in which the rotary body 90 approaches the opening 16a of the frame 16 and the door 14.

As a result of this, when the rotary body 90 rotates and switches from the developing posture to the replacement posture, the rotary body 90 swings about the swing shaft 91. In a state in which the rotary body 90 is in the replacement posture, the developing roller 51 is separated from the photosensitive drum 2.

As illustrated in FIG. 4B, in the black replacement posture, the toner cartridge 70k stops at a position where the toner cartridge 70k faces the opening 16a and the door 14 provided on the side surface 16b of the main body 1A. When the tray 80kis slid from the attached position for the developing unit 50k to the outside of the rotary body 90 from this state, the user can replace the toner cartridge 70k.

### Replacement Operation of Toner Cartridge

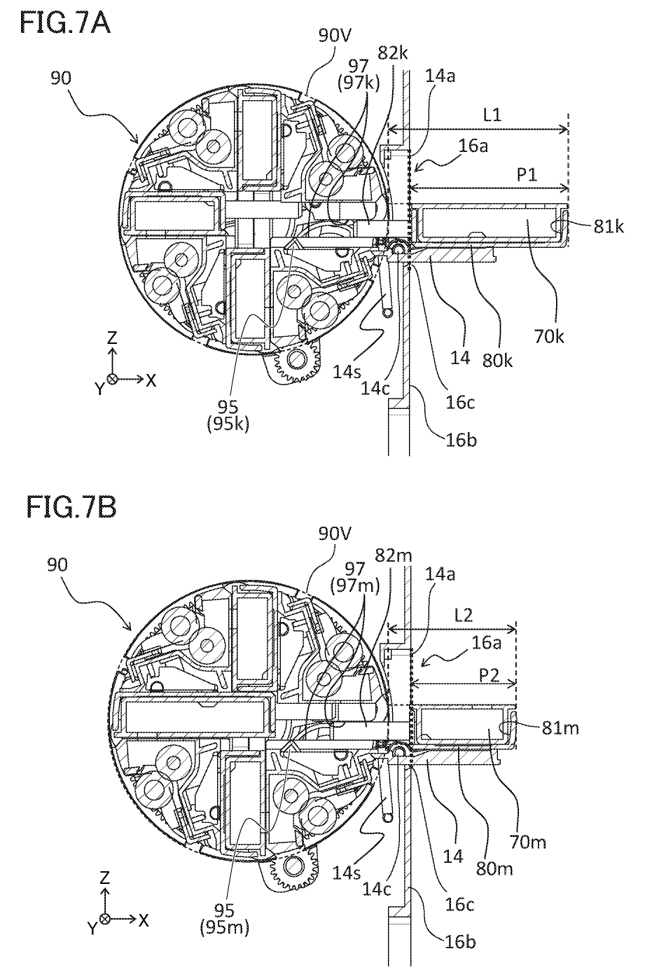

A toner cartridge replacement operation will be described with reference to FIGS. 4A, 6A to 6C, 7A, and 7B. FIGS. 6A to 6C are each an exterior view of the main body 1A. FIGS. 7A and 7B are each a section view of the rotary body 90 and the surroundings thereof in toner cartridge replacement. To be noted, FIGS. 7A and 7B are each a section view of the apparatus taken along a virtual plane orthogonal to the rotational axis 90C of the rotary body 90.

FIG. 6A illustrates an external appearance of the main body 1A during the image forming operation and in a standby state. The image forming operation is during a period in which a series of operations of the image forming apparatus 1 feeding a sheet S, forming an image on the sheet S, and then discharging the sheet S as a product are executed. The standby state is a state in which the image forming operation can be started if the image forming apparatus 1 receives an image forming instruction (printing instruction), and a state in which the image forming apparatus 1 is standing by for the image forming instruction from the user. As illustrated in FIG. 6A, the door 14 is closed during the image forming operation and in the standby state.

FIG. 6B illustrates the external appearance of the main body 1A at the time of toner cartridge replacement. At the time of toner cartridge replacement, the door 14 is opened, and the tray 80 and the toner cartridge 70 are moved to the outside of the main body 1A.

The toner cartridge 70 is movable to an attached position and a retracted position where the toner cartridge 70 is retracted from the attached position, with respect to the developing frame 53 of the developing unit 50. In a state in which the toner cartridge 70 is at the attached position with respect to the developing frame 53, the discharge opening 71b and the inlet opening 53b face each other as illustrated in FIG. 3. As illustrated in FIGS. 4A and 4B, the rotary body 90 is configured to rotate about the rotational axis 90C to take the developing posture and the replacement posture in a state in which the toner cartridge 70 is at the attached position.

The toner cartridge replacement operation will be described. First, the user instructs the controller 30 of the main body 1A of a toner cartridge replacement operation. The instruction of toner cartridge replacement operation is given by, for example, input via an operation panel (operation portion) provided on the main body 1A.

When the controller 30 receives the instruction of the toner cartridge replacement operation, the rotary body 90 rotates to the replacement posture of the toner cartridge 70 serving as a replacement target (toner cartridge 70 whose toner has run out), and stops. That is, the controller 30 rotates the rotary body 90 to the replacement posture of a toner cartridge specified in the instruction of the toner cartridge replacement (in FIG. 4B, the black replacement posture for replacing the black toner cartridge 70k). In the replacement posture, the tray 80 supporting the toner cartridge 70 whose replacement has been instructed faces the opening 16a of the frame 16 of the main body 1A.

For example, the rotary body 90 of FIG. 4A is in the yellow developing posture in which the yellow developing roller 51y faces the photosensitive drum 2. At this time, the black toner cartridge 70k and the tray 80k do not have to face the opening 16a and the door 14. In other words, the toner cartridge 70 and the tray 80 do not have to face the opening 16a and the door 14 in the case where the rotary body 90 is in a developing posture or a replacement posture other than the replacement posture of the toner cartridge. Therefore, the opening 16a may have such a size that each of the toner cartridges 70 can individually pass therethrough. When the rotary body 90 rotates in the clockwise direction in the drawings by a predetermined angle from the yellow developing posture, the black toner cartridge 70k and the tray 80k face the opening 16a and the door 14 as illustrated in FIG. 4B.

Here, “the tray 80 facing the opening 16a” means that the tray 80 is positioned so as to be able to move to the outside of the main body 1A through the opening 16a. That is, in the case where the tray 80 faces the opening 16a, a moving mechanism that will be described later moves the tray 80 outward in the rotational radius direction of the rotary body 90, and therefore the tray 80 and the toner cartridge 70 supported by the tray 80 are capable of projecting to the outside of the main body 1A. In FIG. 4A, none of the trays 80y to 80kfaces the opening 16a. In FIG. 4B, only the black tray 80k faces the opening 16a, and the other trays 80y to 80c do not face the opening 16a.

When the rotary body 90 is positioned in the replacement posture, the motor M2 moves the tray 80 supporting the toner cartridge 70 serving as a replacement target to the outside of the main body 1A. As a result of this, the toner cartridge 70 serving as a replacement target moves from the attached position to the retracted position with respect to the rotary body 90. In addition, as illustrated in FIGS. 6B, 6C, 7A, and 7B, the tray 80 and the toner cartridge 70 serving as a replacement target supported by the tray 80 projects to the outside of the main body 1A through the opening 16a.

More specifically, the tray 80 is movable to an accommodation position and a removal position with respect to the rotary body 90. The accommodation position is a position where the tray 80 is accommodated in the rotary body 90. The removal position is a position (detaching position or replaceable position) where the tray 80 projects to the outside of the rotary body 90 and the toner cartridge 70 can be detached from the tray 80. The positions of the trays 80yto 80kin FIGS. 4A and 4B serve as examples of the accommodation position. The position of the tray 80 in FIGS. 6B and 6C, the position of the tray 80k in FIG. 7A, and the position of the tray 80m in FIG. 7B serve as examples of the removal position.

When the tray 80 is at the accommodation position, the toner cartridge 70 attached to the tray 80 is at the attached position. When the tray 80 is at the removal position, the toner cartridge 70 attached to the tray 80 is at the retracted position.

Here, as illustrated in FIGS. 7A and 7B, the rotary body 90 has projection portions 95 for holding the tray 80 at the accommodation position and holding the toner cartridge 70 at the attached position. As illustrated in FIG. 8, the tray 80 has recess portions 87 configured to be fit on the projection portions 95. FIGS. 7A and 7B illustrate projection portions 95k and 95m corresponding to the trays 80k and 80m, and FIG. 8 illustrates recess portions 87y and 87m of the trays 80y and 80m. The projection portion 95 and the recess portion 87 are provided for each of the trays 80y to 80k. The projection portion 95 may preferably be urged in such a direction as to engage with the recess portion 87.

The projection portion 95 fits in the recess portion 87 of the tray 80, and thus the tray 80 is locked with respect to the rotary frame 90f. As a result of this, the tray 80 stays in the accommodation position even when the rotary body 90 rotates, and thus movement of the toner cartridge 70 from the attached position can be suppressed. To be noted, in the case where the tray 80 is moved between the accommodation position and the removal position by the moving device that will be described below, the projection portion 95 can be configured to be moved by the tray 80 and thus disengaged from the recess portion 87.

In the present embodiment, the door 14 is supported so as to be pivotable with respect to the main body 1A. As illustrated in FIG. 7A, the door 14 is urged from the open position to the closed position by a spring 14s. The spring 14s is, for example, a tension spring, and urges the door 14 such that a moment in a counterclockwise direction in FIGS. 7A and 7B is generated about a support shaft 14c of the door 14.

The tray 80 pushes the door 14, and thus the door 14 takes the open state illustrated in FIG. 6B. This state can be referred to as a state in which the tray 80 is supported by the door 14. The door 14 supports at least part of the tray 80 projecting to the outside of the main body 1A, and thus the toner cartridge 70 can be supported more stably. In other words, when the first toner cartridge (toner cartridge 70k) is at the first retracted position, the opening/closing member (door 14) at the open position supports the first support member (tray 80k). In addition, when the second toner cartridge (one of the toner cartridges 70yto 70c) is at the second retracted position, the opening/closing member (door 14) at the open position supports the second support member (one of the trays 80yto 80c).

To be noted, the door 14 is configured such that the door 14 at the open position comes in contact with part (for example, a lower edge 16c of the opening 16a) of the frame 16 of the main body 1A and not to pivot downward beyond the open position. When the tray 80 is pulled back into the main body 1A from the outside, the door 14 returns to the closed position by the urging force of the spring 14s.

The toner cartridge 70 is detachably held by the tray 80. Therefore, as illustrated in FIG. 6C, the user can perform a work (replacement work) of detaching the toner cartridge 70 from the tray 80 and attaching a new toner cartridge 70. To be noted, in the case of replacing a plurality of toner cartridges 70, the replacement work can be performed by repeating the operation described above.

FIGS. 7A and 7B illustrate a cross-section of the rotary body 90 and the surroundings thereof at the time of toner cartridge replacement. FIG. 7A illustrates a state at the time of replacing the black toner cartridge 70k. FIG. 7B illustrates a state at the time of replacing the magenta toner cartridge 70m.

The image forming apparatus 1 includes the moving device 85 illustrated in FIG. 8 that moves the toner cartridge 70 from the attached position to the retracted position. In the present embodiment, it can be said that the moving device 85 includes the tray 80. A moving device 85k including the tray 80k can be referred to as an example of a first moving device including a first support member. A moving device 85m including the tray 80mcan be referred to as an example of a second moving device including a second support member.

Even when the toner cartridge 70 is at the retracted position, the tray 80 is coupled to the rotary body 90 (supported by the rotary body 90). To easily detach the toner cartridge 70 from the rotary body 90, it may be preferable that the length by which the toner cartridge 70 projects from the rotary body 90 at the retracted position is large. Since the toner cartridge 70 is configured to be attachable to and detachable from the rotary body 90 via the tray 80, the toner cartridge 70 can be stably supported by the tray 80 even in the case where the length by which the toner cartridge 70 projects from the rotary body 90 is large.

The movement direction of the toner cartridge 70 in which the toner cartridge 70 moves from the attached position to the retracted position will be referred to as a retraction direction. In the present embodiment, the retraction direction of the toner cartridge 70 is a direction intersecting with the direction of the rotational axis 90C (Y direction). Therefore, as illustrated in FIGS. 7A and 7B, as viewed in the direction of the rotational axis 90C (Y direction), the retraction direction of the toner cartridge 70 is a direction orthogonal to the direction of the rotational axis 90C (Y direction). In addition, the retraction direction of the toner cartridge 70 can be referred to as a direction outward in the rotational radius direction of the rotary body 90, that is, a direction away from the rotational axis 90C.

As illustrated in FIGS. 7A and 7B, since the user detaches the toner cartridge 70 from the rotary body 90, it may be preferable that the at least part of the toner cartridge 70 projects from the rotary body 90 at the time of detaching the toner cartridge 70. In the present embodiment, the entirety of the toner cartridge 70 projects from the rotary body 90 when the toner cartridge 70 is at the retracted position.

It can be said that when the rotary body 90 rotates about the rotational axis 90C, the rotational trajectory of the rotary body 90 matches a circumscribed circle of the rotary body 90 centered on the rotational axis 90C, that is, a virtual circle 90V indicated by a broken line in FIGS. 7A and 7B. When the toner cartridge 70 is at the retracted position, half the length or more of the toner cartridge 70 in the retracted direction may preferably be outside the rotational trajectory of the rotary body 90. That is, as viewed in the rotational axis direction of the rotary, half the total length or more of the toner cartridge may preferably be positioned outside the rotational trajectory of the rotary in the movement direction of the toner cartridge from the attached position to the retracted position. This applies to the toner cartridges 70 including the toner cartridge 70k serving as an example of the first cartridge and the toner cartridge 70m serving as an example of the second cartridge. In addition, in the present embodiment, the entirety of the toner cartridge 70 is outside the rotational trajectory (virtual circle 90V) of the rotary body 90 when the toner cartridge 70 is at the retracted position as illustrated in FIGS. 7A and 7B.

Further, to make it easier for the user to grab the toner cartridge 70, at least part of the toner cartridge 70 may preferably be outside the image forming apparatus 1, that is, outside the main body 1A when the toner cartridge 70 is at the retracted position. The outside of the apparatus mentioned herein refers to a space that is outside the image forming apparatus 1 (outside the main body 1A) when the image forming apparatus 1 is used for, for example, an image forming operation on the sheet S.

In the present embodiment, the exterior surface of the main body 1A is constituted by the exterior surface of the frame 16. That is, outside the apparatus can be also referred to as outside the frame 16. Therefore, a state in which at least part of the toner cartridge 70 is outside the apparatus can be also referred to as a state in which at least part of the toner cartridge 70 projects to the outside of the frame 16 through the opening 16a of the frame 16 of the main body 1A.

In the present embodiment, when the door 14 is at the closed position, the opening 16a of the frame 16 of the main body 1A is covered by the door 14. Further, the exterior surface 14a of the door 14 at the closed position constitutes part of the exterior surface of the main body 1A. In this case, outside of the apparatus refers to the outside of the exterior surface 14a of the door 14 at the closed position. That is, in the case where the position of the exterior surface 14a of the door 14 at the closed position is referred to as an exterior position, at least part of the toner cartridge 70 is positioned more outward than the exterior position with respect to the main body 1A when the toner cartridge 70 is at the retracted position.

In other words, at least part of the toner cartridge 70 is positioned in a space that would be outside the main body 1A if the door 14 were at the closed position. Further, at least part of the toner cartridge 70 is positioned downstream of the exterior position in the retraction direction of the toner cartridge 70.

In addition, in the case where the side surface 16b having the opening 16a is the front surface of the main body 1A, it can be said at least part of the toner cartridge 70 projects to the front side more than the exterior surface on the front side of the main body 1A when the toner cartridge 70 is at the retracted position. In this case, the user can easily access the toner cartridge 70 from the front side of the image forming apparatus and replace the toner cartridge 70.

To be noted, when the toner cartridge 70 is at the retracted position, half the length or more of the toner cartridge 70 in the retraction direction may preferably be outside the apparatus. That is, as viewed in the rotational axis direction of the rotary, half the total length or more of the toner cartridge may preferably be positioned outside the body frame in the movement direction of the toner cartridge from the attached position to the retracted position in a state in which the toner cartridge is at the retracted position. This applies to the toner cartridges 70 including the toner cartridge 70k serving as an example of the first toner cartridge and the toner cartridge 70m serving as an example of the second toner cartridge. In addition, the entirety of the toner cartridge 70 may preferably be outside the apparatus when the toner cartridge 70 is at the retracted position. To be noted, although the exterior surface 14a of the door 14 and the side surface 16b constitute the exterior surface on the front side of the main body 1A in the present embodiment, the configuration of the door 14 is not limited to this. For example, the size of the door 14 may be set so as to cover the entirety of the side surface 16b. In this case, the exterior surface 14a of the door 14 constitutes the exterior surface on the front side of the main body 1A.

The tray 80 includes a cartridge holding portion 81 illustrated in FIGS. 3 and 6C that holds the toner cartridge 70. The cartridge holding portion 81 is an attached portion to which the toner cartridge 70 is attached. When the tray 80 is at the removal position, the entirety of the cartridge holding portion 81 may preferably be outside the rotational trajectory of the rotary body 90 in the retraction direction. When the tray 80 is at the removal position, half the length or more of the cartridge holding portion 81 may preferably be outside the apparatus in the retraction direction.

Here, as described above, the toner cartridge 70k and the tray 80k are larger in size than the other toner cartridges 70yto 70cand the other trays 80y to 80c. Therefore, as illustrated in FIGS. 7A and 7B, in the present embodiment, the movement amount of the tray 80 in toner cartridge replacement is changed in accordance with the size of the toner cartridge 70.

Specifically, as illustrated in FIG. 7A, the movement distance of the tray 80k (first support member) from the accommodation position (first accommodation position) to the removal position (first removal position) is L1. The movement distance of the tray 80m (second support member) from the accommodation position to the removal position (third removal position) is L2. Although a state in which the toner cartridge 70mand the tray 80m are moved is illustrated in FIG. 7B, the movement distance of the trays 80y and 80c from the accommodation position to the removal position is also L2. In this case, L1 is larger than L2. In other words, it can be said that the movement distance of the first support member in the case where the first toner cartridge moves from the first attached position to the first retracted position is larger than the movement distance of the second support member in the case where the second toner cartridge moves from the second attached position to the second retracted position.

In addition, as illustrated in FIG. 7A, in a state in which the tray 80k is at the removal position and the toner cartridge 70k is at the retracted position, at least part of the toner cartridge 70k projects from the exterior surface of the main body 1A to the outside of the apparatus by a distance P1. In the present embodiment, at least part of the tray 80k also projects from the exterior surface of the main body 1A to the outside of the apparatus by the distance P1. In addition, as illustrated in FIG. 7B, in a state in which the tray 80m is at the removal position and the toner cartridge 70m is at the retracted position, at least part of the toner cartridge 70m projects from the exterior surface of the main body 1A to the outside of the apparatus by a distance P2. In the present embodiment, at least part of the tray 80m also projects from the exterior surface of the main body 1A to the outside of the apparatus by the distance P2. To be noted, the toner cartridges 70y and 70c also project from the exterior surface of the main body 1A to the outside of the apparatus by the distance P2.

The distance P1 described above is larger than the distance P2. That is, the length by which the first toner cartridge at the first retracted position projects through the opening 16a of the main body 1A will be referred to as a first length (P1), and the length by which the second toner cartridge at the second retracted position projects through the opening 16a will be referred to as a second length (P2). In this case, it can be said that the first length is larger than the second length.

It may be preferable in terms of strength that the distance P2 by which the toner cartridges 70y to 70c smaller in size than the toner cartridge 70k project to the outside of the apparatus at the retracted position is smaller than the distance P1 by which the toner cartridge 70k projects to the outside at the retracted position. The reason for this is as follows. When the toner cartridge 70 is at the retracted position, at least part of the toner cartridge 70 projects to the outside of the apparatus from the outside of the rotational trajectory of the rotary body 90 or the exterior surface of the main body 1A. At this time, the tray 80 supports the weight of the toner cartridge 70 in a state in which one side thereof is supported by the rotary body 90. Therefore, reducing the distance P2 by which the toner cartridges 70y to 70c project to the outside of the apparatus at the retracted position can reduce the load on the trays 80y to 80c or guide portions 97 of the rotary body 90 supporting the trays 80y to 80k. In addition, since the toner cartridges 70yto 70c are smaller than the toner cartridge 70k, the operability in the cartridge replacement for the trays 80y to 80b can be maintained even if the distance P2 is set to be smaller than the distance P1.

### Tray Arrangement in Rotary

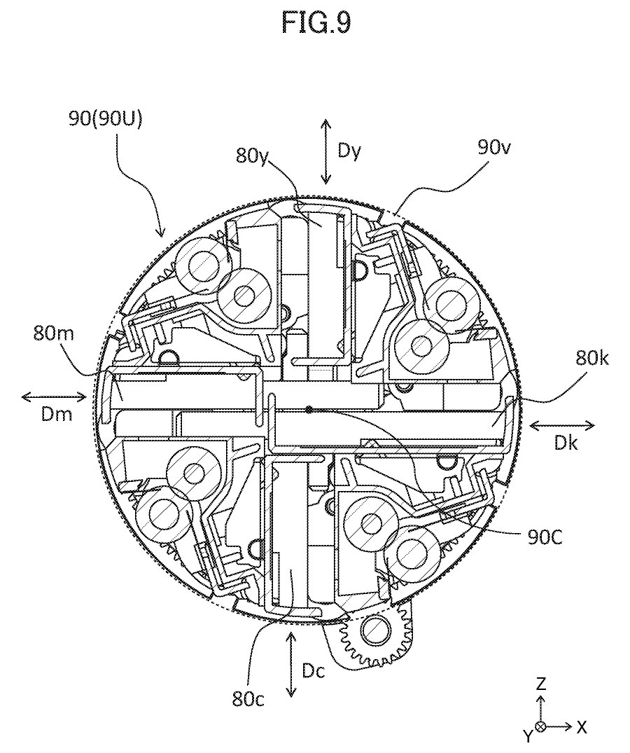

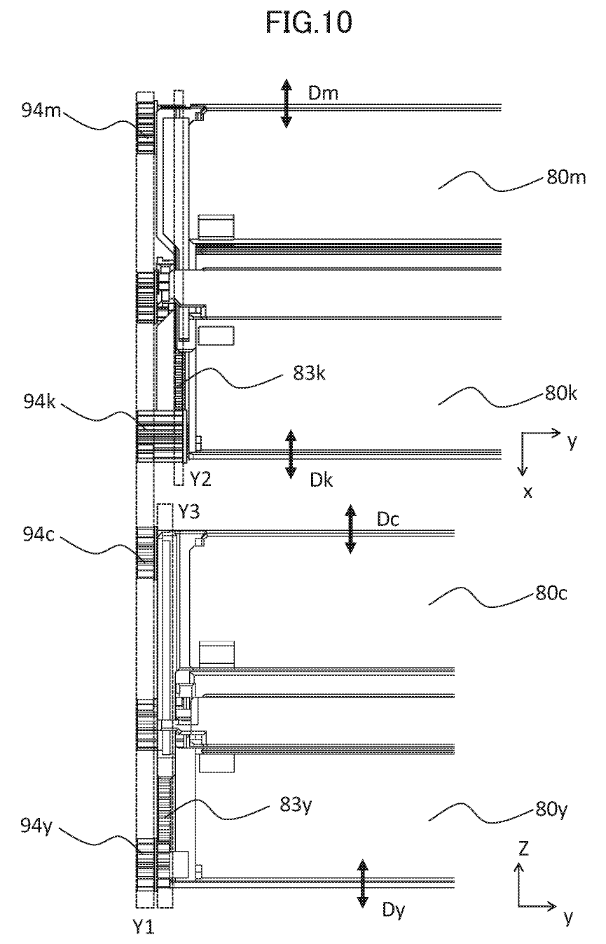

The arrangement of the trays 80y to 80k in the rotary body 90 will be described with reference to FIGS. 8, 9, and 10. FIG. 8 is a perspective view illustrating the arrangement of the trays 80y to 80k in the rotary body 90. FIG. 9 is a section view illustrating the arrangement of the trays 80y to 80k in the rotary body 90. FIG. 10 is a diagram illustrating the member arrangement of the trays 80y to 80k on one end side in the Y direction. To be noted, FIG. 9 illustrates a cross-section of the rotary body 90 taken along a virtual plane orthogonal to the rotational axis 90C of the rotary body 90. In addition, the top half of FIG. 10 is a diagram of the rotary body 90 and the trays 80m and 80k of FIG. 8 as viewed from the upper-right side (+Z side) of FIG. 8, and the lower half of FIG. 10 is a diagram of the rotary body 90 and the trays 80c and 80y of FIG. 8 as viewed from the left side (-X) side of FIG. 8.

As illustrated in FIG. 8, the trays 80y, 80m, 80c, and 80k are respectively provided with cartridge holding portions 81y, 81m, 81c, and 81k and respectively provided with guided portions 82y, 82m, 82c, and 82k.

The toner cartridges 70y to 70k are respectively attached to the cartridge holding portions 81y to 81k. The cartridge holding portions 81y to 81k respectively accommodate at least part of the toner cartridges 70y to 70k attached thereto.

The guided portions 82y to 82k are provided at respective end portions of the trays 80y to 80k such that the cartridge holding portions 81y to 81k are each interposed therebetween in the Y direction. The guided portions 82y to 82k are each a thin and long member extending in a direction orthogonal to the rotational axis of the rotary body 90.

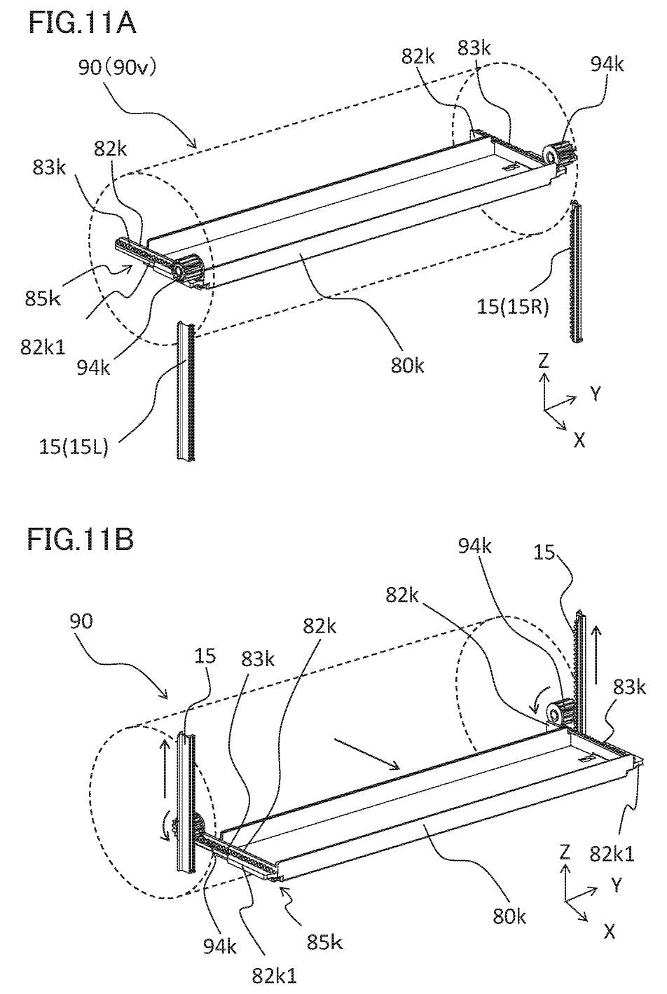

In the present embodiment, a reinforcing rib 82k1 is formed on part of the guided portion 82k in a movement direction Dk of the tray 80k, and a reinforcing rib 82m1 is formed on part of the guided portion 82m in a movement direction Dm of the tray 80m as illustrated in FIGS. 11A and 11B. The reinforcing ribs 82k1 and 82m1 are thin and long rib shapes (ridges) projecting outward in the Y direction from the guided portions 82k and 82m of the respective end portions of the trays 80k and 80m in the Y direction and extending in the movement directions Dk and Dm of the trays 80k and 80m. The reinforcing ribs 82k1 and 82m1 improve the stiffness of the guided portions 82k and 82m.

To be noted, although the lengths of the reinforcing ribs 82m1 and 82k1 in the present embodiment are restricted so as to avoid the guided portions 82y and 82c, the reinforcing ribs 82m1 and 82k1 may be provided for the entire lengths of the guided portions 82m and 82k unless interference with the guided portions 82y and 82c occurs. Reinforcing ribs may be added to the guided portions 82y and 82c. In addition, in the case where the stiffness of the guided portions 82m and 82k is sufficient, a configuration in which the reinforcing ribs 82m1 and 82k1 are not provided may be employed.

The guided portions 82y to 82k have rack portions (rack gears) 83y to 83k formed therein. In addition, pinion gears 94yto 94k are rotatably held in the rotary body 90. The pinion gears 94y to 94k are respectively engaged with the rack portions 83y to 83k in a manner capable of transmitting a driving force.

The rack portions 83y to 83k and the pinion gears 94y to 94k are part of the moving devices 85y to 85k configured to move the toner cartridges 70y to 70k from the attached position to the retracted position. In addition, it can be said that the rack portions 83y to 83k and the pinion gears 94y to 94k are part of a driven device driven by the driving device 98 of the main body 1A. It can be said that the pinion gears 94y to 94k are rotatable bodies (rotary members) that rotate to move the trays 80y to 80k with respect to the rotary body 90.

The pinion gears 94y to 94k and the rack portions 83y to 83k function as driven portions for the moving devices 85y to 85k of the rotary body 90 to receive the driving force from the driving device 98 of the main body 1A. The pinion gear 94k and the rack portion 83k are examples of a first pinion gear and a first rack gear constituting at least part of a first driven portion included in a first moving device. The pinion gear 94m and the rack portion 83mare examples of a second pinion gear and a second rack gear constituting at least part of a second driven portion included in a second moving device.

The rotary body 90 includes guide portions 97 illustrated in FIGS. 7A and 7B that respectively engage with the guided portions 82y to 82k. FIG. 7A illustrates the guide portion 97 (97k) that engages with the guided portion 82k of the tray 80k, and FIG. 7B illustrates the guide portion 97 (97m) that engages with the guided portion 82m of the tray 80m. The rotary body 90 includes similar guide portions that respectively engage with the guided portions 82y and 82c of the trays 80y and 80c. In addition, although the guide portions 97 provided on one side (+Y side) of the rotary body 90 in the Y direction are illustrated in FIGS. 7A and 7B, similar guide portions 97 are also provided on the other side (-Y side) of the rotary body 90 in the Y direction.

When the tray 80 moves between the accommodation position and the removal position, the guide portion 97 maintains the state of engaging with the guided portion 82 in at least part of the movement range, and guides the movement direction of the tray 80. In the present embodiment, the guide portion 97 maintains the state of engaging with the guided portion 82k in the entirety of the movement range of the tray 80k between the accommodation position and the removal position. In addition, in the present embodiment, the guide portion 97 maintains the state of engaging with the guided portion 82m in the entirety of the movement range of the tray 80m between the accommodation position and the removal position.

In addition, as illustrated in FIGS. 8 and 9, the four trays 80y to 80k are disposed in the rotary body 90 so as to overlap each other as will be described in detail below.

When the pinion gears 94y to 94k rotate, the rack portions 83y to 83k and the trays 80y to 80k move with respect to the rotary body 90. As illustrated in FIG. 9, the four trays 80y to 80k are arranged such that the movement directions thereof with respect to the rotary body 90 are rotated by 90° from each other. Therefore, the tray 80y and the tray 80c are held so as to be slidable in substantially the same direction (parallel directions) as each other, and the tray 80m and the tray 80k are held so as to be slidable in substantially the same direction (parallel directions) as each other. The movement directions of sliding of the trays 80y to 80k are regulated by the engagement between the guide portions 97 and the guided portions 82y to 82k described above.

To be noted, the trays 80y to 80k move to the outside of the apparatus through the opening 16a. When the trays 80y to 80k each move to the outside of the apparatus through the opening 16a, the movement directions of the trays are substantially the same (parallel).

As illustrated in FIG. 9, the trays are disposed such that with respect to the movement direction Dk of the tray 80k, the range in which the tray 80k is disposed overlaps with the range in which the tray 80y is disposed and the range in which the tray 80c. In addition, with respect to the movement direction Dk of the tray 80k, the range in which the tray 80k is disposed overlaps with the rotational axis 90C of the rotary body 90. That is, it can be said that the toner cartridge 70k held by the cartridge holding portion 81k of the tray 80k overlaps with the rotational axis 90C of the rotary body 90 illustrated in FIG. 4B.

In contrast, the trays are disposed in a displaced manner such that with respect to the movement direction Dm of the tray 80m, the range in which the tray 80m is disposed does not overlap with the range in which the tray 80y is disposed and the range in which the tray 80c is disposed. Further, the trays are disposed in a displaced manner such that with respect to a movement direction Dy of the tray 80y, the range in which the tray 80y is disposed does not overlap with the range in which the tray 80m is disposed and the range in which the tray 80k is disposed. Similarly, the trays are disposed in a displaced manner such that with respect to a movement direction Dc of the tray 80c, the range in which the tray 80c is disposed does not overlap with the range in which the tray 80m is disposed and the range in which the tray 80k is disposed.

The positional relationship between the trays 80 can be also expressed as follows. As viewed in the movement direction Dy of the tray 80y, the tray 80y and the tray 80k overlap with each other, but the tray 80y and the tray 80m do not overlap with each other. As viewed in the movement direction Dm of the tray 80m, the tray 80m and the tray 80k overlap with each other, but the tray 80m and the trays 80y and 80c do not overlap with each other. As viewed in the movement direction Dc of the tray 80c, the tray 80c and the tray 80k overlap with each other, but the tray 80c and the tray 80m do not overlap with each other.

Here, two elements (such as members, parts, and units) overlapping as viewed in a specific direction refers to a projected region of one element and a projected region of the other element at least partially overlapping with each other in the case where the elements are orthogonally projected onto a virtual plane orthogonal to the specific direction.

As illustrated in FIGS. 8 and 10, with respect to the direction of the rotational axis 90C (Y direction), a range in which the rack portion 83m and the guided portion 82m are disposed and a range in which the rack portion 83k and the guided portion 82k are disposed overlap with each other at least partially. That is, in the present embodiment, it can be said that with respect to the rotational axis direction of the rotary (Y direction), a range in which the first rack gear (rack portion 83k) is disposed and a range in which the second rack gear (rack portion 83m) is disposed overlap with each other at least partially. Therefore, as compared with a layout in which the rack portion 83m and the guided portion 82m do not overlap with the rack portion 83k and the guided portion 82k, the rack portions 83m and 83k and the guided portions 82m and 82k can be arranged in a smaller space in the Y direction.

With respect to the direction of the rotational axis 90C (Y direction), a range in which the rack portion 83y and the guided portion 82y are disposed and a range in which the rack portion 83c and the guided portion 82c are disposed overlap with each other at least partially. That is, in the present embodiment, it can be said that with respect to the rotational axis direction of the rotary (Y direction), a range in which the third rack gear (rack portion 83y) is disposed and a range in which the fourth rack gear (rack portion 83c) is disposed overlap with each other at least partially. Therefore, as compared with a layout in which the rack portion 83y and the guided portion 82y do not overlap with the rack portion 83c and the guided portion 82c, the rack portions 83y and 83c and the guided portions 82y and 82c can be arranged in a smaller space in the Y direction.

Here, an engagement position between the rack portion 83 and the pinion gear 94 will be described with reference to FIG. 10. A top half portion of FIG. 10 illustrates an engagement position between the rack portion 83k and the pinion gear 94k. A lower half portion of FIG. 10 illustrates an engagement position between the rack portion 83y and the pinion gear 94y.

In a region Y1 in the drawings in the direction of the rotational axis 90C of the rotary body 90 (Y direction), the driving force transmitted from the motor M2 illustrated in FIG. 2A serving as a drive source to a transmission device that will be described below is transmitted to the pinion gears 94y to 94k. In a region Y2 in the drawings in the Y direction, the pinion gear 94k is engaged with the rack portion 83k in a manner capable of transmitting the driving force. In a region Y3 in the drawings in the Y direction, the pinion gear 94y is engaged with the rack portion 83y in a manner capable of transmitting the driving force. To be noted, the rack portion 83m is engaged with the pinion gear 94m illustrated in FIG. 8 in the region Y2 similarly to the rack portion 83k in a manner capable of transmitting the driving force. The rack portion 83c is engaged with the pinion gear 94c illustrated in FIG. 8 in the region Y3 similarly to the rack portion 83y in a manner capable of transmitting the driving force.

Here, the regions Y2 and Y3 are at different positions in the Y direction, that is, are displaced from each other in the Y direction. In addition, the region Y1 is at a position different from both the regions Y2 and Y3 in the Y direction. That is, the region Y1 is displaced from the regions Y2 and Y3 in the Y direction.

Further, in a state in which the toner cartridges 70y and 70c are at the attached position, with respect to a movement direction of the rack portion 83y (movement direction Dy of the tray 80y), a range in which the rack portion 83y is disposed and a range in which the rack portion 83c is disposed overlap with each other at least partially. In the present embodiment, since the movement directions Dy and Dc of the trays 80y and 80c are substantially the same (parallel), also with respect to the movement direction Dc of the tray 80c, a range in which the rack portion 83y is disposed and a range in which the rack portion 83c is disposed overlap with each other at least partially. Therefore, in a state in which the toner cartridges 70y and 70c are at the attached position, the tooth surface of the rack portion 83y faces the tooth surface of the rack portion 83c in a direction (left-right direction of FIG. 8) orthogonal to the movement directions Dy and Dc of the rack portions 83y and 83c.

Further, in a state in which the toner cartridges 70m and 70k are at the attached position, with respect toa movement direction of the rack portion 83m (movement direction Dm of the tray 80m), a range in which the rack portion 83m is disposed and a range in which the rack portion 83k is disposed overlap with each other at least partially. In the present embodiment, since the movement directions Dm and Dk of the trays 80m and 80k are substantially the same (parallel), also with respect to the movement direction Dk of the tray 80k, a range in which the rack portion 83m is disposed and a range in which the rack portion 83k is disposed overlap with each other at least partially. Therefore, in a state in which the toner cartridges 70m and 70k are at the attached position, the tooth surface of the rack portion 83m faces the tooth surface of the rack portion 83k in a direction (up-down direction of FIG. 8) orthogonal to the movement directions Dm and Dk of the rack portions 83m and 83k.

In addition, the rack portion 83y overlaps with the rack portions 83m and 83k as viewed in the direction (Y direction) of the rotational axis 90C. As viewed in the direction (Y direction) of the rotational axis 90C, the rack portion 83m overlaps with the rack portions 83y and 83c. As viewed in the direction (Y direction) of the rotational axis 90C, the rack portions 83c overlaps with the rack portion 83k and 83m. As viewed in the direction of the rotational axis 90C (Y direction), the rack portions 83k overlaps with the rack portion 83c and 83y. In other words, it can be said that with respect to the rotational axis direction of the rotary (Y direction), a range in which the first rack gear (rack portion 83k) is disposed does not overlap with a range in which the second rack gear (rack portion 83y) is disposed. In addition, it can be said that, as viewed in the rotational axis direction of the rotary (Y direction), in a state in which the first toner cartridge 70k is at the first attached position and the second toner cartridge 70y is at the second attached position, the first rack gear (rack portion 83k) and the second rack gear (rack portion 83y) overlap with each other.

As described above, since the positions where the rack portions 83k and 83m are disposed and the positions where the rack portions 83y and 83c are disposed are different in the Y direction, the rack portions can be arranged such that the rack portions 83y and 83c overlap with the rack portions 83m and 83k as viewed in the Y direction.

As a result of this, the space for arranging the four trays in the rotary body 90 can be reduced, and thus the size of the rotary body 90 in the rotational radius direction can be reduced. That is, when it is attempted to arrange the rack portions 83 such that the movement distances of the trays 80y to 80k are equivalent to those of the present embodiment and the rack portions 83 do not overlap with each other as viewed in the Y direction, the area required for the arrangement of the four rack portions is large as viewed in the Y direction. As compared with such a configuration, as a result of arranging the plurality of rack portions 83 in a displaced manner in the Y direction such that the rack portions 83 overlap with each other as viewed in the Y direction, the installation area for the rack portions 83 as viewed in the Y direction can be reduced.

In addition, in the present embodiment, two pairs of two of the four rack portions 83y to 83k are arranged in a displaced manner in the Y direction. That is, it can be said that with respect to in the rotational axis direction of the rotary (Y direction), the range in which the first rack gear is disposed and the range in which the second rack gear is disposed overlap with each other, and the range in which the third rack gear is disposed and the range in which the fourth rack gear is disposed overlap with each other. In addition, it can be said that with respect to the Y direction, the range in which the first rack gear and the second rack gear are disposed does not overlap with the range in which the third rack gear and the fourth rack gear are disposed. As a result of this, the size of the rotary body 90 in the Y direction can be reduced as compared with a case where all the four rack portions 83y to 83k are arranged in a displaced manner in the Y direction.

### Moving Elements of Tray

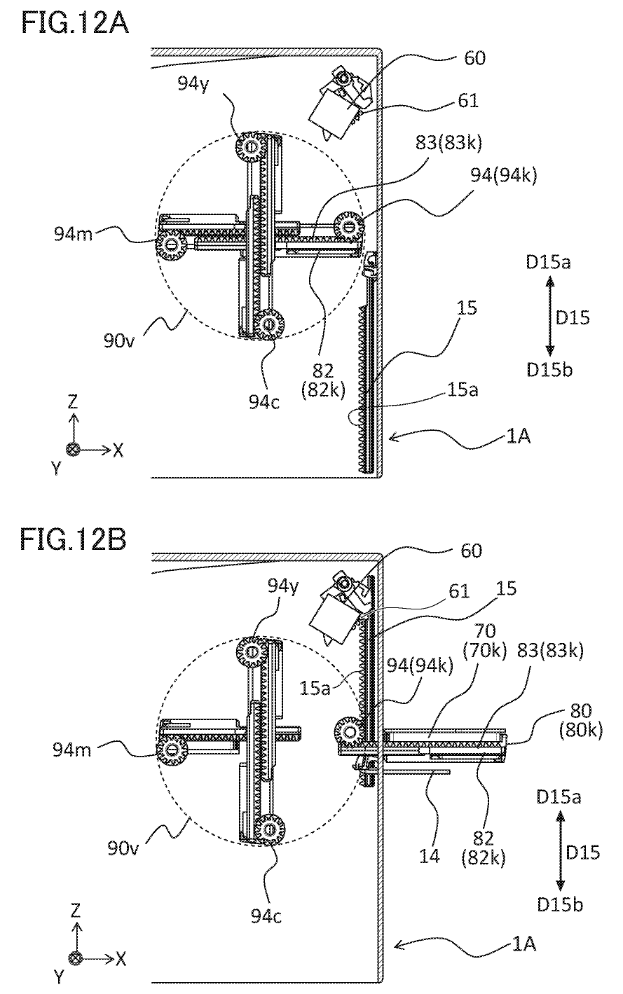

Elements related to the movement of the trays 80y to 80k disposed in the rotary body 90 will be described with reference to FIGS. 11A, 11B, 12A, and 12B. FIGS. 11A and 11B are each a perspective view of elements related to the movement of the tray 80k. FIGS. 12A and 12B are each a section view of elements related to the movement of the tray 80k.

In the present embodiment, the trays 80y to 80k are respectively driven by receiving the driving force of the motor M2 transmitted to the pinion gears 94y to 94k via the driving racks 15L and 15R serving as transmission devices. Here, the elements for moving the tray 80k with respect to the rotary body 90 will be described, and since the elements for moving the trays 80y to 80c with respect to the rotary body 90 are substantially the same as the elements for moving the tray 80k, description thereof will be omitted.

FIG. 11A illustrates a state in which the tray 80k is inside the rotary body 90, that is, in a state in which the toner cartridge 70k is attached to the developing unit 50k. That is, FIG. 11A illustrates a state in which the tray 80k is at the accommodation position, and corresponds to a state in which the toner cartridge 70k is at the attached position with respect to the developing frame 53k illustrated in FIG. 4A. FIG. 11B illustrates a state in which the tray 80k has slid to the outside of the rotary body 90. That is, FIG. 11B illustrates a state in which the tray 80k is at the removal position, and corresponds to a state in which the toner cartridge 70k is at the retracted position with respect to the developing frame 53k illustrated in FIGS. 4A and 4B.

The main body 1A of the present embodiment includes the driving racks 15L and 15R serving as driving gears that drive the pinion gears 94. The driving racks 15 are each driven by the motor M2 via the unillustrated drive transmission mechanism.

As described above, two rack portions 83k are formed at respective end portions of the tray 80k in the Y direction. Two pinion gears 94k and the driving racks 15L and 15R are disposed at positions respectively corresponding to the rack portions 83k at the respective end portions. That is, the main body 1A of the present embodiment includes the driving racks 15L and 15R serving as the first driving gear and the second driving gear. It can be said that the driving rack 15L is an example of a first driving gear, and the driving rack 15R is an example of a second driving gear. However, this numbering is merely used for the sake of convenience of description, and can be appropriately interchanged in principle. In the case where there is no need to distinguish the driving racks 15L and 15R from each other, the driving racks will be each described as a “driving rack 15”.

The rack portions 83 of the present embodiment are configured as a pair of rack gears, and the pinion gears 94 of the present embodiment are configured as a pair of pinion gears. The pair of rack gears and the pair of pinion gears are disposed on the two end sides (i.e., one end side and the other end side) of the support member (tray 80) in the Y direction in the present embodiment, but the pair of rack gears and the pair of pinion gears may be disposed at other positions. The rack portions 83k and the pinion gears 94k of the moving device 85k corresponding to the tray 80k can be respectively referred to as examples of a first pair of rack gears and a first pair of pinion gears. The rack portions 83y to 83c and the pinion gears 94y to 94c of the moving devices 85y to 85c respectively corresponding to the other trays 80y to 80c can be respectively referred to as examples of second pairs of rack gears and second pairs of pinion gear.

One of the pair of rack gears engages with one of the pair of pinion gears, and the other of the pair of rack gears engages with the other of the pair of pinion gears. At least one of the pair of pinion gears is driven by the driving rack 15L serving as a first driving rack. In the present embodiment, two of the pair of pinion gears are simultaneously driven by the driving racks 15L and 15R serving as a first driving rack and a second driving rack. As a result of this, rotation of the tray 80 is less likely to occur, and thus stable movement of the toner cartridge 70 is made possible.

To be noted, a configuration in which the tray 80 includes one rack portion 83 and is moved by one driving rack 15 via one pinion gear 94 may be employed.

The tray 80k is held to be slidable in a direction parallel to the guided portion 82k (that is, the movement direction Dk) with respect to the rotary body 90. The driving rack 15 is held to be slidable in a direction intersecting with the movement direction Dk of the tray 80k with respect to the main body 1A. The driving rack 15 is configured to slide (reciprocate) in a first direction (vertically upward direction in the present embodiment) and a second direction (vertically downward direction in the present embodiment) opposite to the first direction, with respect to the main body 1A. That is, the movement direction of the driving rack 15 of the present embodiment is a direction intersecting with both the movement direction Dk of the tray 80k and the direction of the rotational axis 90C of the rotary body 90 (Y direction). The movement direction of the driving rack 15 may preferably be orthogonal to both the movement direction Dk and the direction of the rotational axis 90C.

A tray moving operation of sliding the tray 80k between the accommodation position and the removal position will be described with reference to FIGS. 11A and 11B. The tray moving operation of the tray 80k is performed by the motor M2 illustrated in FIG. 2A, an unillustrated drive transmission mechanism, the driving rack 15, the pinion gear 94k, and the rack portion 83k.

First, a tray moving operation (tray pull-out operation) of detaching the toner cartridge 70k from the rotary body 90 will be described. In a state before the tray pull-out operation is started, the driving rack 15 illustrated in FIG. 11A is positioned below a position where the driving rack 15 engages with the pinion gear 94k. In addition, as described above, in the replacement operation of the toner cartridge 70k, the rotary body 90 takes the replacement posture illustrated in FIG. 4B for the toner cartridge 70k.

When the tray pull-out operation is started, the driving racks 15 are slid upward with respect to the main body 1A by the driving force of the motor M2. In the course of movement of the driving racks 15, the driving racks 15 engage with the pinion gears 94k, and the pinion gears 94k are rotationally driven.

As illustrated in FIG. 11B, the pinion gears 94k are rotationally driven in an arrow direction in FIG. 11B, and thus the driving force is input to the rack portions 83k engaged with the pinion gears 94k. As a result of this, the tray 80kis pushed to the outside of the apparatus, and moves from the accommodation position to the removal position with respect to the rotary body 90. The movement direction of the tray 80k in this movement is guided to the predetermined movement direction Dk by the engagement between the guided portion 82k and the guide portion 97k of the rotary body 90 illustrated in FIG. 7A. As a result of the tray 80k moving from the accommodation position to the removal position, the toner cartridge 70k is moved from the attached position to the retracted position with respect to the developing unit 50k.

In a state in which the tray 80k is positioned at the removal position and the toner cartridge 70k is positioned at the retracted position, the user can attach and detach the toner cartridge 70k to and from the tray 80k.

The tray moving operation (tray pull-in operation or tray insertion operation) at the time of attaching the toner cartridge 70 to the rotary body 90 is performed in a process reversed from the tray pull-out operation. For example, the tray pull-in operation is started in response to the user operating a predetermined operation portion. When the tray pull-in operation is started, the driving racks 15 are slid downward with respect to the main body 1A by the driving force of the motor M2. Here, the rotational direction of the motor M2 in the tray pull-in operation is opposite to that in the tray pull-out operation.

As a result of the pinion gears 94k being rotationally driven in a direction opposite to the arrow of FIG. 11B, the driving force is input to the rack portions 83k engaged with the pinion gears 94k. As a result of this, the tray 80k is pulled into the apparatus, and moves from the removal position to the accommodation position with respect to the rotary body 90. The tray 80k is guided in the movement direction Dk opposite to the arrow of FIG. 11B by the engagement between the guided portion 82k and the guide portion 97k of the rotary body 90. As a result of the tray 80k moving from the removal position to the accommodation position, the toner cartridge 70k is moved from the retracted position to the attached position with respect to the developing unit 50k.

Movement of the tray 80k and the toner cartridge 70k for black has been described above, and movement of the other trays 80y to 80cand toner cartridges 70y to 70c is also performed by a similar mechanism. That is, the driving racks 15 transmit drive to the pinion gears 94y to 94c in respective replacement postures of the toner cartridges.

The motor M2 provided in the main body 1A and the transmission device including the driving racks 15 (15L and 15R) and the drive transmission mechanism constitute the driving device 98 for driving the moving devices 85 provided in the rotary body 90.

As described above, in the present embodiment, a plurality of moving devices 85k to 85y corresponding to the plurality of toner cartridges 70k to 70y are disposed in the rotary body 90. The driving device 98 of the main body 1A is a common driving device that drives the plurality of moving devices 85kto 85y (plurality of driven devices) of the rotary body 90.

In addition, in the present embodiment, the driving target of the driving device 98 switches in accordance with the rotation of the rotary body 90. In other words, the driving device of the present embodiment includes the driving racks 15 each serving as a transmission member that transmits the driving force of the drive source. The driving device can take a state in which the transmission member engages with a first driven portion (e.g., pinion gear 94k) in a manner capable of transmitting the driving force and a state in which the transmission member engages with a second driven portion (e.g., pinion gear 94m) in a manner capable of transmitting the driving force. In addition, the driving device can take a state in which the transmission member is disengaged from the first driven portion and the second driven portion.

As described above, the pinion gears 94y to 94k are held by the rotary body 90. Therefore, when the rotary body 90 rotates, it may be preferable that the engagement between the driving racks 15 and the pinion gears 94y to 94kis released.

FIG. 12A illustrates a state in which the tray 80k is inside the rotary body 90, that is, a state in which the tray 80k is at the accommodation position. FIG. 12B illustrates a state in which the tray 80k has moved to the outside of the rotary body 90, that is, a state in which the tray 80k has moved to the removal position.

As illustrated in FIG. 12A, when the tray 80k is inside the rotary body 90, the driving racks 15 are positioned in a lower portion in the main body 1A. At this time, the driving racks 15 are retracted from the pinion gears 94k. Therefore, the rotary body 90 can be rotated without being interrupted by the driving racks 15. More specifically, the driving racks 15 can be retracted to the outside of the rotational trajectory of the rotary body 90 indicated by dotted lines in FIGS. 12A and 12B.

As described above, by rotationally driving the motor M2 in a normal direction and a reverse direction, the tray 80 attached to the rotary body 90 can be moved from the accommodation position to the removal position and from the removal position to the accommodation position with respect to the rotary body 90. That is, the driving device of the present embodiment can drive the moving devices such that not only the toner cartridges move from the attached position to the retracted position but also the toner cartridges move from the retracted position to the attached position.

### Memory Tag and Reading Apparatus

A memory tag 72 (storage medium, storage element) serving as a storage portion provided in the toner cartridge 70, and the reading apparatus 60 will be described with reference to FIGS. 12A to 15B.

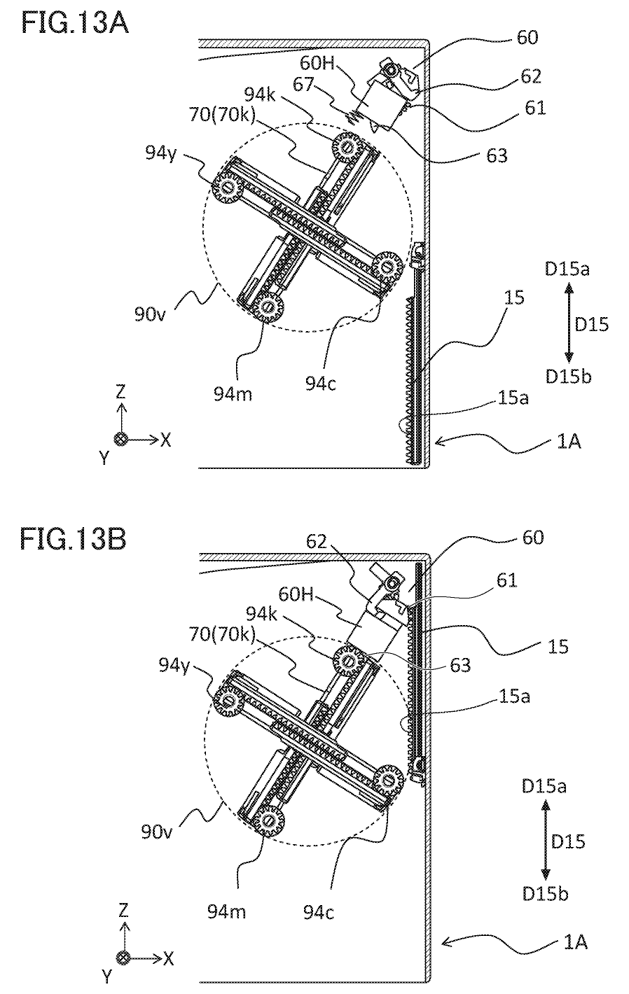

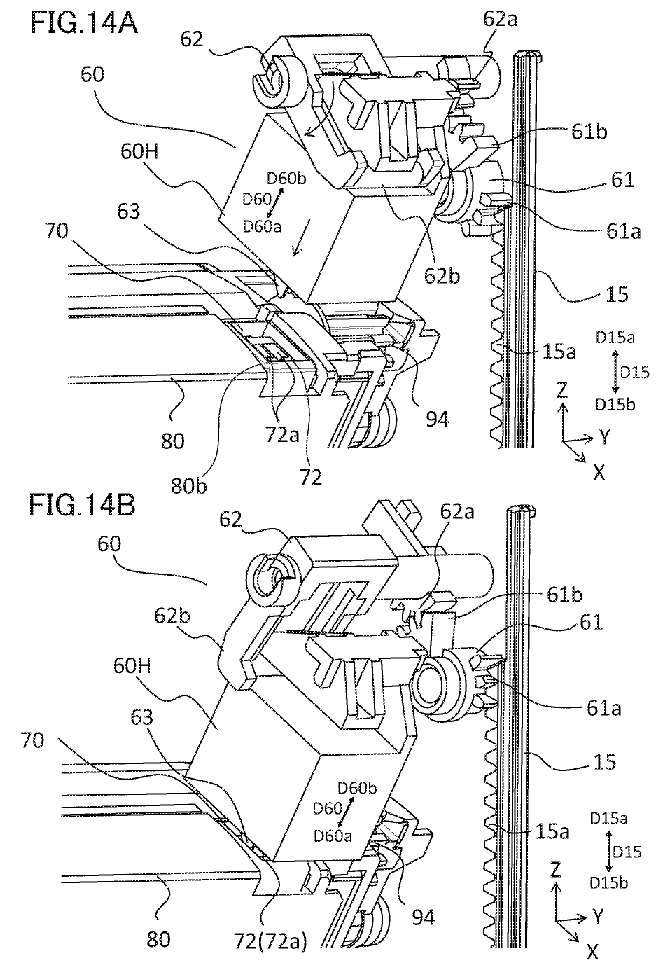

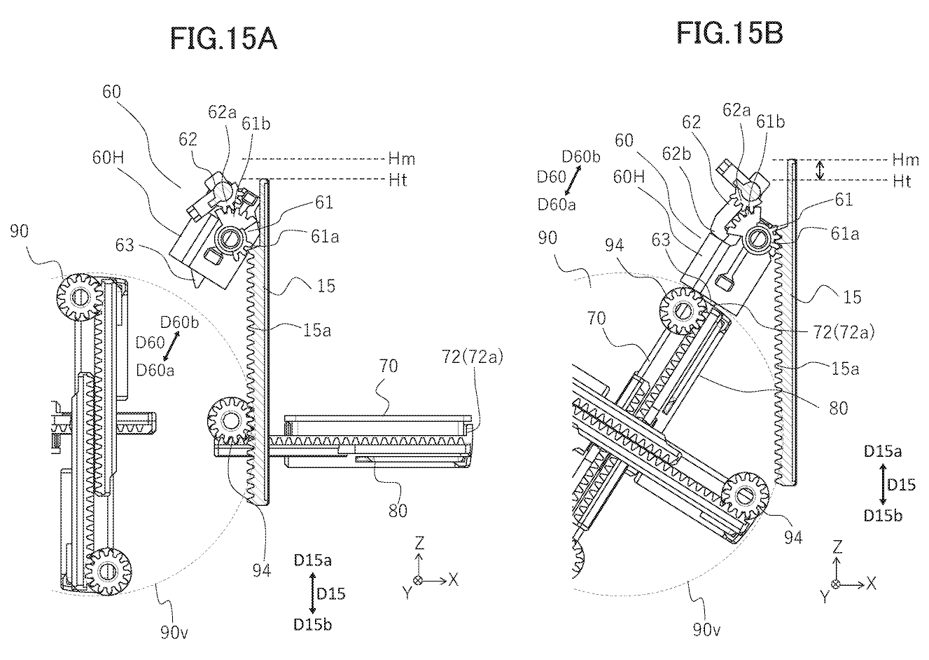

FIGS. 13A and 13B are each an explanatory diagram illustrating movement of a reading head 60H (reading portion) of the reading apparatus 60 according to the first embodiment. FIGS. 14A and 14B are each a perspective view of the reading apparatus 60 according to the first embodiment. FIGS. 15A and 15B are each an explanatory diagram illustrating the movement amount of the driving rack 15 according to the first embodiment. To be noted, FIGS. 12A, 12B, 13A, 13B, 15A, and 15B are each a section view of part of the image forming apparatus 1 as viewed in the direction (Y direction) of the rotational axis of the rotary body 90.

As illustrated in FIGS. 5, 14A, and 14B, the memory tag 72 serving as a storage portion that stores information about the toner cartridge 70 is attached to the toner cartridge 70. The memory tag 72 of the present embodiment includes a semiconductor memory chip (tag body) and one or more tag contacts 72a (cartridge-side contacts) exposed to the outside of the toner cartridge 70. Particularly, the memory tag 72 of the present embodiment includes two tag contacts 72a arranged in the Y direction.

The information stored in the memory tag 72 is not particularly limited, and may be, for example, identification information such as a production lot number of the toner cartridge 70, or information indicating an attribute of the toner stored in the toner cartridge 70. The attribute of the toner is, for example, the color, stored amount, or the like of the toner. The memory tag 72 may simultaneously store a plurality of pieces of information of different uses.

As illustrated in FIG. 5, in a state in which each toner cartridge 70 is attached to the rotary body 90, the tag contact 72a of the memory tag 72 is exposed to the outside of the rotary body 90. That is, as viewed in at least one direction orthogonal to the direction (Y direction) of the rotational axis of the rotary body 90, at least part of the tag contact 72a is not covered by the rotary frame 90f or the tray 80 attached to the rotary body 90. The tray 80 may be provided with a cutout 80b for exposing the tag contact 72a. The cutout 80b is formed in a wall surface 80a on the far side from the rotational axis 90C of the rotary body 90 of the cartridge holding portion 81 that holds the toner cartridge 70. To be noted, illustration of the memory tag 72 and the cutout 80b is omitted in FIGS. 6A to 6C, 8, 11A, and 11B.

The tag contact 72a is provided to face outward in the rotational radius direction of the rotary body 90 in a state in which the toner cartridge 70 is attached to the rotary body 90. In addition, in a state in which the four toner cartridges 70 are attached to the rotary body 90, the four memory tags 72 are positioned at an interval of 90° each in the rotational direction of the rotary body 90. That is, each time the rotary body 90 rotates by 90°, a memory tag 72 moves to a position that has been occupied by another memory tag 72 before the rotary body 90 is rotated. For example, when the rotary body 90 rotates by 90° from the position illustrated in FIG. 5, a memory tag 72-2 on the lower side in the drawing moves to the position of a memory tag 72-1 on the upper side in the drawing.

As illustrated in FIGS. 13A, 13B, 14A, and 14B, the reading apparatus 60 includes a reading head 60H, a reading pinion 61, and a head moving member 62. The reading head 60H includes a reading contact 63 (body-side contact, second contact) configured to come into contact with the tag contact 72a (cartridge-side contact, first contact) of the memory tag 72.

The reading contact 63 of the reading head 60H is electrically connected to the controller 30. Therefore, via the contact between the tag contact 72a (first contact) and the reading contact 63 (second contact), the controller 30 of the main body 1A is electrically connected to the memory tag 72 of the toner cartridge 70.

The reading pinion 61 and the head moving member 62 function as a movement mechanism that moves the reading head 60H by the driving force of the motor M2 transmitted via the driving rack 15.

The reading pinion 61 includes a first gear portion 61a and a second gear portion 61b. The first gear portion 61a is configured to engage with the plurality of teeth 15a of the driving rack 15. The first gear portion 61a is an engaged portion engaged with the driving rack 15 (driving member). In addition, the first gear portion 61a is an input portion where the driving force is input to the reading apparatus 60 from the driving rack 15 (driving member).

The plurality of teeth 15a of the driving rack 15 are arranged in an intersecting direction intersecting with the direction (Y direction) of the rotational axis of the rotary body 90, and the driving rack 15 is capable of reciprocating in the intersecting direction. The driving rack 15 of the present embodiment is configured to reciprocate in the Z direction serving as the intersecting direction.

In the present embodiment, the teeth 15a of the driving rack 15 engage with the pinion gear 94 of the rotary body 90 in the tray moving operation (tray pull-out operation, tray pull-in operation) described above. That is, the force transmission portion (teeth 15a) of the driving rack 15 that transmits a force to the pinion gear 94 (first force receiving portion) of the rotary body 90 also functions as a force transmission portion of the driving rack 15 that transmits a force to the reading pinion 61 (second force receiving portion) of the reading apparatus 60. As a result of this, the configuration of the driving rack 15 that drives both the rotary body 90 and the reading apparatus 60 can be simplified.

To be noted, a force transmission portion that engages with the pinion gear 94 of the rotary body 90 may be provided in the driving rack 15 in addition to the teeth 15a that engage with the reading pinion 61. In addition, the mechanism in which the driving rack 15 engages with the reading apparatus 60 and force is transmitted is not limited to engagement of a gear, and, for example, a leading end of the driving rack 15 may directly press a protrusion portion provided in the head moving member 62 to rotate the head moving member 62.

The head moving member 62 of the present embodiment includes a third gear portion 62a and a pressing portion 62b (arm portion, cam portion). The third gear portion 62a is engaged with the second gear portion 61b of the reading pinion 61. The pressing portion 62b is configured to abut the reading head 60H and press the reading head 60H in a direction approaching the rotational axis of the rotary body 90.

The reading pinion 61 and the head moving member 62 are each rotatably supported by the frame 16 of the main body 1A. The reading pinion 61 and the head moving member 62 each rotate about a rotational axis extending in a direction intersecting with the movement direction D15 of the driving rack 15. The reading pinion 61 of the present embodiment rotates about a rotational axis (first axis) parallel to the rotational axis 90C of the rotary body 90. The head moving member 62 of the present embodiment rotates about a rotational axis (first axis) parallel to the rotational axis 90C of the rotary body 90 and the rotational axis of the reading pinion 61.

The reading head 60H (reading portion) is capable of reciprocating in a head moving direction D60 intersecting with the direction (Y direction) of the rotational axis of the rotary body 90. In the head moving direction D60, a direction from the retracted position toward a reading position will be referred to as an approaching direction D60a, and a direction from the reading position toward the retracted position will be referred to as a retracting direction D60b.

The reading head 60H is movable with respect to the rotary body 90 between a reading position (FIGS. 13B and 14B) and a retracted position (FIG. 13A and 14A) retracted from the reading position.

The pressing portion 62b of the head moving member 62 is configured to press the reading head 60H in the approaching direction D60a. In addition, the reading head 60H is urged in the retracting direction D60b by an urging member 67 such as a spring as schematically illustrated in FIG. 13A.

The reading apparatus 60 is disposed on one end side of the main body 1A in the direction of the rotational axis of the rotary body 90. The reading apparatus 60 of the present embodiment is disposed at an end portion on the +Y side of the main body 1A, and the reading head 60H is moved by the driving force transmitted from the driving rack 15R on the +Y side. To be noted, the reading apparatus 60 may be disposed at an end portion on the -Y side of the main body 1A such that the driving force is transmitted from the driving rack 15L on the -Y side. In the description below, the driving rack 15R that transmits the driving force to the reading apparatus 60 will be simply referred to as a “driving rack 15”.

The reading position of the reading head 60H is a position of the reading head 60H when the controller 30 reads information from the memory tag 72 via the reading head 60H (reading portion). The retracted position of the reading head 60H is a position retracted from the reading position. More specifically, the retracted position of the reading head 60H is a position farther from the rotational axis 90C of the rotary body 90 than the reading position.

In the case where the reading head 60H is at the retracted position, the entirety of the reading head 60H may preferably be positioned outside a virtual circle 90v that is a virtual circle circumscribing the rotary body 90 as viewed in the direction of the rotational axis 90C of the rotary body 90 (FIG. 13A). In contrast, in the case where the reading head 60H is at the reading position, part of the reading head 60H (particularly part of the reading contact 63) may be positioned inside the virtual circle 90v of the rotary body 90 as viewed in the direction of the rotational axis 90C of the rotary body 90 (FIG. 13B).

In the present embodiment, the reading of the information from the memory tag 72 (storage portion) by the controller 30 via the reading head 60H (reading portion) refers to input of an electric signal indicating the information stored in the memory tag 72 to the controller 30 via the reading head 60H (reading portion). That is, the reading of information via the reading head 60H (reading portion) in the present embodiment refers to input of an electric signal from the memory tag 72 (storage portion) to the controller 30 via the reading head 60H and the contact portion between the tag contact 72a and the reading contact 63.

In the present embodiment, the agent of the control based on the information obtained from the memory tag 72 is the controller 30. The reading head 60H (reading portion) of the present embodiment merely provides a communication path for the controller 30 to access the memory tag 72 (storage portion) to obtain the information. That is, the reading head 60H is part of the electric circuit of the main body 1A. To be noted, for example, the reading apparatus 60 itself may include an integrated circuit (IC) chip that temporarily stores information read from the memory tag 72 and transmits the information in response to a request from the controller 30. That is, the reading apparatus 60 may include a control portion that reads information of the memory tag 72 via the reading head 60H.

The control based on the information obtained from the memory tag 72 is, for example, determination on whether or not an appropriate toner cartridge 70 is attached, or processing performed at the time of erroneous attachment. For example, the controller 30 determines that erroneous attachment has occurred on the basis of the information obtained from the memory tag 72 in the case where the toner cartridge 70m of a wrong color (for example, magenta) is attached to the yellow developing unit 50y. In this case, the controller 30 prohibits execution of the image forming operation and notifies the user of the erroneous attachment of the toner cartridge 70.

The control based on the information obtained from the memory tag 72 is not limited to the example described above. For example, the control may be control to change the execution conditions of the image forming operation in accordance with the attribute of the toner stored in the toner cartridge 70. In addition, in the case where the toner cartridge 70 is replaced, the type of the replaced toner cartridge 70 may be determined on the basis of the information obtained from the memory tag 72 and the display of the toner remainder amount in the operation panel may be updated.

### Reading of Memory Tag

The reading operation in which the controller 30 reads the information from the memory tag 72 via the reading head 60H will be described with reference to FIGS. 12A, 12B, 13A, and 13B. The reading operation is executed in the case where, for example, the toner cartridge 70 is replaced. FIGS. 12A to 13B illustrate replacement of the black toner cartridge 70k and a reading operation on the memory tag 72 of the black toner cartridge 70k. The operation of the apparatus on the other toner cartridges 70y, 70m, and 70c is substantially the same as in FIGS. 12A to 13B except that the posture of the rotary body 90 is different. Therefore, the suffices y, m, c, and k will be omitted in the description below.

First, the movement of the driving rack 15 in replacement of the toner cartridge 70 will be described with reference to FIGS. 12A and 12B. In a state in which the driving rack 15 and the pinion gear 94 are engaged, the driving force of the motor M2 is transmitted to the rotary body 90 via the pinion gear 94 such that the toner cartridge 70 moves with respect to the rotary body 90. In the present embodiment, the toner cartridge 70 is moved in a direction intersecting with the rotational axis direction of the rotary body 90 by the driving force of the motor M2. More specifically, the tray pull-out operation is executed in a state in which the rotary body 90 is in the replacement posture as illustrated in FIG. 12A. That is, the driving rack 15 is moved in the first movement direction D15a (ascending direction) by the driving force of the motor M2, and the tray 80 is pulled out from the accommodation position to the removal position (FIG. 12B).

In the tray pull-out operation, the teeth 15a of the driving rack 15 engage with the pinion gear 94 serving as a first force receiving portion of the rotary body 90, and thus the driving force is transmitted from the driving rack 15 to the rotary body 90. That is, in the case where the rotary body 90 is in the replacement posture, the pinion gear 94 (first force receiving portion) is located at a position engageable with the driving rack 15 (driving member). More specifically, as viewed in the direction (Y direction) of the rotational axis 90C of the rotary body 90 in a state in which the rotary body 90 is in the replacement posture, the pinion gear 94 is located at a position intersecting with the movement trajectory of the plurality of teeth 15a of the driving rack 15 moving in the movement direction D15 (intersecting direction). In contrast, in the tray pull-out operation, the teeth 15a of the driving rack 15 do not engage with the reading pinion 61 serving as a force receiving portion (second force receiving portion) of the reading apparatus 60.

The tray pull-in operation is performed after the user has replaced the toner cartridge 70 in the state of FIG. 12B. That is, the driving rack 15 is moved in the second movement direction D15b by the driving force of the motor M2, and the tray 80 is pulled in from the removal position to the accommodation position (FIG. 12A). In a state in which the toner cartridge 70 is at the attached position, the driving rack 15 is away from the pinion gear 94. That is, in a state in which the tray 80 is at the accommodation position, the driving rack 15 is away from the pinion gear 94.

After the tray pull-in operation, the rotary body 90 is rotated to a black reading posture illustrated in FIG. 13A from a black replacement posture by the driving force of the motor M1. The driving rack 15 is maintained at a lower position illustrated in FIG. 13A while the rotary body 90 is rotated from the black replacement posture to the black reading posture.

Here, the posture of the rotary body 90 when the memory tag 72 of the black toner cartridge 70 is read will be referred to as a black reading posture. The posture of the rotary body 90 when the memory tag 72 of the cyan toner cartridge 70c is read will be referred to as a cyan reading posture. The posture of the rotary body 90 when the memory tag 72 of the magenta toner cartridge 70m is read will be referred to as a magenta reading posture. The posture of the rotary body 90 when the memory tag 72 of the yellow toner cartridge 70y is read will be referred to as a yellow reading posture. In addition, the posture of the rotary body 90 when the memory tag 72 of arbitrary one of the toner cartridges 70 is read will be referred to as a reading posture.

In the case where the rotary body 90 is in the reading posture, the tag contact 72a of the memory tag 72 of the toner cartridge 70 attached to the rotary body 90 opposes the reading contact 63 in the head moving direction D60. For example, in the case where the rotary body 90 is in the black reading posture, the tag contact 72a of the memory tag 72 of the toner cartridge 70 attached to the rotary body 90 opposes the reading contact 63 in the head moving direction D60. Similarly, in the cases where the rotary body 90 is in the cyan reading posture, the magenta reading posture, and the yellow reading posture, the tag contacts 72a of the toner cartridges 70c, 70m, and 70y each oppose the reading contact 63 in the head moving direction D60.

When the rotary body 90 is rotated from the black replacement posture to the black reading posture as illustrated in FIG. 13A, the driving rack 15 is moved in the first movement direction D15a by the driving force of the motor M2.

Here, in the case where the rotary body 90 is in the reading posture as illustrated in FIG. 13A, the pinion gear 94 (first force receiving portion) of the rotary body 90 is located at a position not engageable with the driving rack 15. That is, when the rotary body 90 is in the reading posture, the pinion gear 94 is outside the movement trajectory of the driving rack 15 (space that the driving rack 15 passes through). When the rotary body 90 is viewed in the direction (Y direction) of the rotational axis 90C of the rotary body 90 in a state in which the rotary body 90 is in the reading posture in the present embodiment, the pinion gear 94 is at a position not overlapping with the movement trajectory of the plurality of teeth 15a of the driving rack 15 moving in the movement direction D15 (intersecting direction). Therefore, even if the driving rack 15 is moved in the first movement direction D15a in a state in which the rotary body 90 is in the black reading posture, drive is not transmitted from the driving rack 15 to the pinion gear 94. In addition, since the drive transmission from the driving rack 15 to the pinion gear 94 is not performed, the tray 80 and the toner cartridge 70 do not move with respect to the rotary body 90.

When the driving rack 15 is further moved in the first movement direction D15a, the driving rack 15 engages with the reading pinion 61 (second force receiving portion), and drive transmission is performed to move the reading head 60H. Specifically, the teeth 15a of the driving rack 15 engage with the first gear portion 61a of the reading pinion 61 as illustrated in FIG. 14A, and the reading pinion 61 starts rotating. As a result of the engagement between the second gear portion 61b and the third gear portion 62a, the head moving member 62 rotates in the clockwise direction in the drawings in accordance with the rotation of the reading pinion 61, and the pressing portion 62b of the head moving member 62 presses the reading head 60H. As a result of this, the reading head 60H moves in the approaching direction D60a from the retracted position toward the reading position.

When the leading end of the driving rack 15 in the first movement direction D15a (upper end of the driving rack 15 in the present embodiment) moves up to a predetermined position, the reading head 60H reaches the reading position as illustrated in FIGS. 13B and 14B. In addition, the reading contact 63 comes into contact with the tag contact 72a before at least the reading head 60H reaches the reading position. As a result of this, the controller 30 of the main body 1A is communicably connected to the memory tag 72.

When the communication between the controller 30 and the memory tag 72 is finished, the controller 30 rotates the motor m2 in the reverse direction, and moves the driving rack 15 in a second movement direction D15b (descending direction). The reading pinion 61 and the head moving member 62 rotate in accordance with the movement of the driving rack 15, and thus the pressing portion 62b of the head moving member 62 moves in the retracting direction D60b. Then, the reading head 60H moves from the reading position to the retracted position by the urging force of the urging member 67, and the reading contact 63 is separated from the tag contact 72a. When the teeth 15a of the driving rack 15 is separated from the first gear portion 61a of the reading pinion 61, the reading apparatus 60 returns to the state of FIG. 14A.

### Regarding Movement Amount of Driving Rack

The movement amount of the driving rack 15 in replacement of the toner cartridge 70 and in reading of the memory tag 72 will be described with reference to FIGS. 15A and 15B. FIG. 15A illustrates a stopping position of the driving rack 15 in replacement of the toner cartridge 70. FIG. 15B illustrates a stopping position of the driving rack 15 in reading of the memory tag 72.

The stopping position of the driving rack 15 in replacement of the toner cartridge 70 refers to the position of the driving rack 15 when the tray pull-out operation described above is completed. The stopping position of the driving rack 15 in reading of the memory tag 72 refers to a position of the driving rack 15 when the movement of the reading head 60H from the retracted position to the reading position in the reading operation described above is completed. In addition, in the description below, the position of the driving rack 15 is based on the position of the leading end of the driving rack 15 in the movement direction (first movement direction D15a) of the driving rack 15 in the tray pull-out operation.

In the tray pull-out operation in replacement of the toner cartridge 70, the driving rack 15 moves in the first movement direction D15a from the lower position (FIG. 13A) to a first stopping position Ht illustrated in FIG. 15A. In contrast, in reading of the memory tag 72, the driving rack 15 moves to a second stopping position Hm downstream of the first stopping position Ht in the first movement direction D15a. The driving rack 15 of the present embodiment engages with the reading pinion 61 in a section between the first stopping position Ht and the second stopping position Hm.

In other words, when the tray 80 (support member) is moved from the accommodation position to the removal position, the driving rack 15 (driving member) moves from the lower position (first position) to the first stopping position Ht (second position). When the reading head 60H (reading portion) is moved from the retracted position to the reading position, the driving rack 15 moves to the second stopping position Hm (third position) downstream of the first stopping position Ht in the first movement direction D15a from the lower position toward the first stopping position Ht. In addition, the position where the driving rack 15 moving in the first movement direction D15a starts engaging with the reading pinion 61 (second force receiving portion) is downstream of the first stopping position Ht in the first movement direction D15a.

If the driving rack 15 moves to the second stopping position Hm also in replacement of the toner cartridge 70, the driving rack 15 engages with the reading pinion 61 also in replacement of the toner cartridge 70, and the reading head 60H moves. In this case, the wear of the driving rack 15, the reading pinion 61, the head moving member 62, and the like is accelerated, or the power consumption of the motor M2 increases needlessly. In addition, depending on the configuration of the rotary body 90, there is a possibility that the reading contact 63 comes into contact with a portion different from the memory tag 72, and the reading contact 63 or the portion that has touched the reading contact 63 is deformed.

According to the present embodiment, the driving rack 15 stops at the first stopping position Ht and does not engage with the reading pinion 61 (second force receiving portion) in replacement of the toner cartridge 70. That is, the driving rack 15 (driving member) of the present embodiment does not engage with the reading pinion 61 (second force receiving portion) in the movement range of the driving rack 15 of the case where the tray 80 (support member) is moved from the accommodation position to the removal position. The driving rack 15 of the present embodiment (driving member) engages with the reading pinion 61 (second force receiving portion) outside the movement range of the driving rack 15 of the case where the tray 80 (support member) is moved form the accommodation position to the removal position. Therefore, the inconvenience described above can be avoided.

The stopping position (first stopping position Ht) of the driving rack 15 in replacement of the toner cartridge 70 may preferably be set in consideration of the operability in the replacement work of the toner cartridge 70. For example, in a state in which the tray pull-out operation is completed as illustrated in FIGS. 7A and 7B, the first stopping position Ht may be set such that the tray 80 and the toner cartridge 70 protrude to the outside of the apparatus by a sufficient protrusion amount (P1, P2).

The controller 30 controls the stopping position (movement amount) of the driving rack 15 on the basis of, for example, the length of time in which the motor M2 is rotated. The configuration is not limited to this, and a sensor that detects the position of the driving rack 15 may be added and the controller 30 may control the stopping position (movement amount) of the driving rack 15 on the basis of the detection signal of the sensor. The sensor that detects the position of the driving rack 15 is, for example, a photo-interrupter which is disposed such that light thereof is blocked by part of the driving rack 15 and which outputs a signal corresponding to whether or not the driving rack 15 is at a predetermined position.

Incidentally, a case where the distance from the first stopping position Ht to the second stopping position Hm is longer is more advantageous in that the load for moving the reading head 60H is smaller, but this can also lead to increase in the size of the apparatus.

Therefore, the reading apparatus 60 of the present embodiment is configured such that the movement amount of the reading head 60H is larger than the movement amount of the driving rack 15. The reading pinion 61 and the head moving member 62 of the present embodiment function as an acceleration mechanism that accelerates and transmits the movement of the driving rack 15 to the reading head 60H. That is, in the case where the reading head 60H (reading portion) is moved by the driving force transmitted from the driving rack 15 (driving member), the movement amount of the pressing portion 62b of the head moving member 62 (moving member) is larger than the movement amount of the first gear portion 61a (engaged portion) of the reading pinion 61 (second force receiving portion) engaged with the driving rack 15.

More specifically, in the present embodiment, the pitch circle radius of the third gear portion 62a of the head moving member 62 is smaller than the pitch circle radius of the second gear portion 61b of the reading pinion 61. Therefore, when the reading pinion 61 and the head moving member 62 rotate, the angular velocity of the head moving member 62 is higher than the angular velocity of the reading pinion 61. In other words, the reading pinion 61 (second force receiving portion) and the head moving member 62 (moving member) are configured to rotate in an interlocked manner with each other, and are configured such that the angular velocity of the head moving member 62 is higher than the angular velocity of the reading pinion 61.

In addition, in the present embodiment, the rotational radius of the pressing portion 62b that presses the reading head 60H is larger than the pitch circle radius of the third gear portion 62a of the head moving member 62. That is, the reading pinion 61 (second force receiving portion) and the head moving member 62 (moving member) rotate in an interlocked manner with each other, and the rotational radius of the pressing portion 62b when the head moving member 62 rotates is larger than the rotational radius of the first gear portion 61a (engaged portion) when the reading pinion 61 rotates. Therefore, when the head moving member 62 rotates, the movement amount of the pressing portion 62b is larger than the movement amount of the teeth on the pitch circle of the third gear portion 62a.

The example described above is merely an example, and a different acceleration mechanism may be used. For example, a pressing portion (cam portion) that presses the reading head 60H may be formed coaxially with the reading pinion 61, and the first gear portion 61a (engaged portion) and the pressing portion may be configured to rotate integrally. In this case, this functions as an acceleration mechanism if the rotational radius of the pressing portion 62b is larger than the pitch circle radius of the first gear portion 61a. In addition, a stepped gear including a small-diameter gear that engages with the driving rack 15 and a large-diameter gear that engages with the head moving member 62 may be used as the reading pinion 61. By using the acceleration mechanism, the apparatus can be miniaturized while securing a movement amount of the reading head 60H.

To be noted, in the case where it is difficult to provide the acceleration mechanism, a configuration in which the driving rack 15 engages with the reading pinion 61 also in replacement of the toner cartridge 70 may be employed. That is, a configuration in which the driving rack 15 engages with the reading pinion 61 at a position upstream of the first stopping position Ht in the first movement direction D15a may be employed. In this case, it may be preferable that the reading head 60H does not come into contact with the rotary body 90 even in a state in which the driving rack 15 has reached the first stopping position Ht in replacement of the toner cartridge 70.

### Driving Speed of Driving Rack

Here, the fact that the driving speed of the driving rack 15 by the motor M2 differs between during replacement of the toner cartridge 70 and during reading of the memory tag 72 will be described.

In the description below, in the reading operation described with reference to FIGS. 13A and 13b, the operation in which the reading head 60H (reading portion) is moved from the reading position to the retracted position will be referred to as a reading start operation, and the operation in which the reading head 60H is moved from the retracted position to the reading position will be referred to as a reading finish operation.

The driving target and the drive transmission path differ between during replacement of the toner cartridge 70 and during reading of the memory tag 72. In replacement of the toner cartridge 70, the driving target is the toner cartridge 70, the driving force is transmitted from the motor M2 to the force receiving portion (pinion gear 94) of the moving device 85 via the driving rack 15, and thus the toner cartridge 70 is moved by the moving device 85. In reading of the memory tag 72, the driving target is the reading apparatus 60, the driving force is transmitted from the motor M2 to the force receiving portion (reading pinion 61) of the reading apparatus 60 via the driving rack 15, and thus the reading head 60H (reading portion) is moved.

Due to the difference in the driving target and the drive transmission path, the load that the motor M2 receives differs between during replacement of the toner cartridge 70 and during reading of the memory tag 72. In the present embodiment, the load that the motor M2 receives during replacement of the toner cartridge 70 is larger than the load that the motor M2 receives during reading of the memory tag 72. For example, the load that the motor M2 receives in the tray pull-out operation and the load that the motor M2 receives in the tray pull-in operation are larger than the load that the motor M2 receives in the reading start operation. In addition, the load that the motor M2 receives in the tray pull-out operation and the load that the motor M2 receives in the tray pull-in operation are larger than the load that the motor M2 receives in the reading finish operation.

The performance of the motor M2 (rated torque, rated output, and the like) is selected in consideration of the load in replacement of the toner cartridge 70, which is a larger load. Therefore, the load that the motor M2 receives during reading of the memory tag 72, which is a smaller load, is smaller than the torque (rated torque) that the motor M2 can stably output, which means that the motor output has some margin.

Meanwhile, the usability is improved more if the reading operation of the memory tag 72 is completed as quickly as possible. For example, a case where, the controller 30 allows start of the image forming operation by using the completion of the reading operation of the memory tag 72 as one of the conditions in the case where the user has replaced the toner cartridge 70 can be considered. In this case, the waiting time (period in which the image forming apparatus 1 cannot execute the image forming operation, downtime) for the user is shorter and the usability is improved more if the time required for the movement of the reading head 60H is shorter.

Therefore, the driving speed of the driving rack 15 is set to different values between during replacement of the toner cartridge 70 and during reading of the memory tag 72. In the present embodiment, the driving speed of the driving rack 15 during reading of the memory tag 72 is set to a value higher than the driving speed of the driving rack 15 during replacement of the toner cartridge 70.

More specifically, the driving speed of the driving rack 15 in the reading start operation is higher than the driving speed of the driving rack 15 in the tray pull-out operation. In addition, the driving speed of the driving rack 15 in the reading start operation is higher than the driving speed of the driving rack 15 in the tray pull-in operation. The driving speed of the driving rack 15 in the reading finish operation is higher than the driving speed of the driving rack 15 in the tray pull-out operation. The driving speed of the driving rack 15 in the reading finish operation is higher than the driving speed of the driving rack 15 in the tray pull-in operation.

Here, the driving speed of the driving rack 15 in the reading start operation is the maximum value of the movement speed of the driving rack 15 in a period in which the reading head 60H (reading portion) moves from the retracted position to the reading position. The driving speed of the driving rack 15 in the reading finish operation is the maximum value of the movement speed of the driving rack 15 in a period in which the reading head 60H (reading portion) moves from the reading position to the retracted position.

The driving speed of the driving rack 15 in the tray pull-out operation is the maximum value of the movement speed of the driving rack 15 in a period in which the toner cartridge 70 moves from the attached position to the retracted position (detachment position) by the tray pull-out operation. The driving speed of the driving rack 15 in the tray pull-in operation is the maximum value of the movement speed of the driving rack 15 in a period in which the toner cartridge 70 moves from the retracted position (detachment position) to the attached position by the tray pull-in operation.

Incidentally, in the reading operation of the memory tag 72, the driving rack 15 performs a series of reciprocating movement in which the driving rack 15 moves from the lower position illustrated in FIG. 13A to the upper position illustrated in FIG. 13B and then returns to the lower position. In the present embodiment, the driving speed of the driving rack 15 may be constat in a period in which the driving rack 15 moves from the lower position to the upper position and a period in which the driving rack 15 moves from the upper position to the lower position. To be noted, as will be described in a third embodiment, the driving speed of the driving rack 15 may be changed between the lower position and the upper position.

In addition, in the present embodiment, the driving speeds of the driving rack 15 in the tray pull-out operation and the tray pull-in operation are constant, but the driving speed may be changed in these operation periods. In addition, in the present embodiment, although the driving speed of the driving rack 15 in the tray pull-out operation is equal to the driving speed of the driving rack 15 in the tray pull-in operation, these driving speeds may be different.

### Summary of Present Embodiment

As described above, according to the present embodiment, the reading head 60H (reading portion) is movable with respect to the rotary body 90 (rotary) between a reading position where information of the memory tag 72 (storage portion) is read and a retracted position retracted from the reading position. In addition, the pinion gear 94 (first force receiving portion) is configured to receive a driving force and transmit the driving force to the rotary body 90 in a state in which the driving rack 15 (driving member) is engaged with the pinion gear 94 (first force receiving portion). In addition, the reading pinion 61 (second force receiving portion) is configured to receive the driving force and transmit the driving force to the reading head 60H (reading portion) in a state in which the driving rack 15 (driving member) is engaged with the reading pinion 61 (second force receiving portion), such that the reading head 60H (reading portion) is moved between the reading position and the retracted position by the driving force transmitted via the driving rack 15.

As described above, the driving rack 15 serving as a driving member that transmits a driving force to the rotary body 90 (rotary) also plays a role to transmit the driving force to move the reading head 60H (reading portion). Therefore, the configuration of the image forming apparatus 1 can be simplified as compared with a case where, for example, a dedicated driving member for driving the reading apparatus 60 is provided in addition to the driving member that engages with the pinion gear 94 of the rotary body 90. That is, according to the present embodiment, a function to move the reading head 60H (reading portion) in the image forming apparatus 1 of a rotary development system can be realized by a simple configuration.

In addition, according to the present embodiment, the tray 80 (support member) supporting the toner cartridge 70 is moved by the driving force transmitted from the driving rack 15 serving as a driving member to the pinion gear 94 (first force receiving portion). As a result of this, a function to move the reading head 60H and a function to move the tray 80 to facilitate attachment and detachment of the toner cartridge 70 can be realized by a simpler configuration.

In addition, according to the present embodiment, the reading head 60H is capable of accessing the memory tag 72 provided in each of the plurality of toner cartridges 70 (70y to 70k). In the present embodiment, the reading head 60H is capable of coming into contact with the memory tag 72 provided in each of the plurality of toner cartridges 70 (70y to 70k). That is, the controller 30 is capable of reading information from the memory tag 72 provided in each of the plurality of toner cartridges 70 (70y to 70k) via one reading head 60H (reading portion). For example, in the case where the yellow toner cartridge 70y is referred to as a first toner cartridge, the magenta toner cartridge 70m can be referred to as a second cartridge including the memory tag 72 serving as a second storage portion. The controller 30 can read information from both the memory tag 72 of the first cartridge and the memory tag 72 (second storage portion) of the second cartridge via the reading head 60H (reading portion).

In addition, the driving speed of the driving rack 15 (driving member) when the reading head 60H (reading portion) is moved from the retracted position to the reading position will be referred to as a second driving speed. The driving speed of the driving rack 15 (driving member) when the toner cartridge 70 is moved from the attached position to the retracted position (detachment position) will be referred to as a first driving speed. In this case, according to the present embodiment, the second driving speed is higher than the first driving speed.

As a result of this, the time required for the movement of the reading head 60H can be shortened, and thus the waiting time for the user can be shortened. That is, in a configuration in which the movement of the reading head 60H (reading portion) and the movement of the toner cartridge 70 are performed by the same drive source (motor M2), the usability can be improved.

### Modification Example

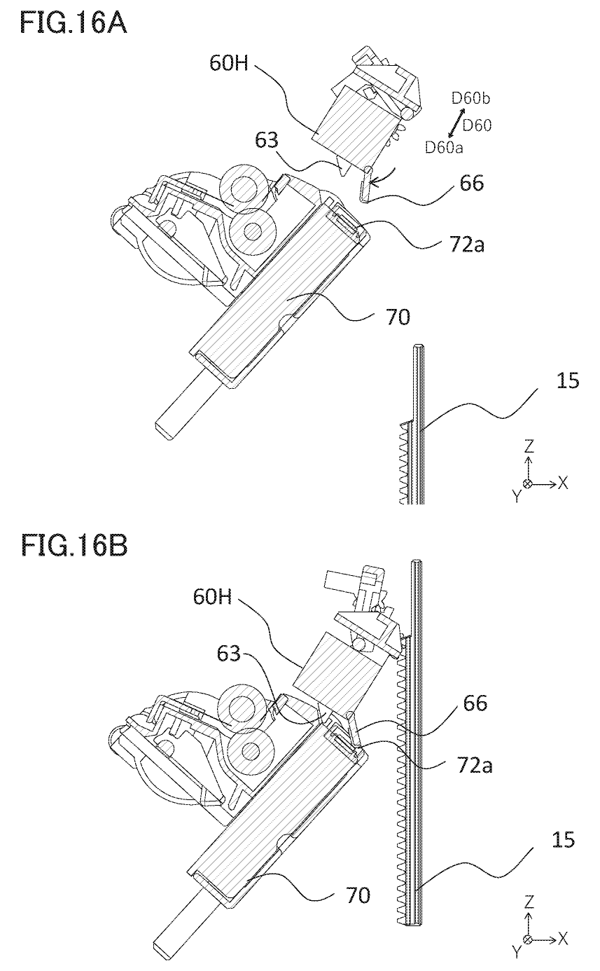

An image forming apparatus according to a modification example will be described with reference to FIGS. 16A and 16B. The present modification example is different from the first embodiment in that a cleaning member 66 capable of cleaning the tag contact 72a (first contact) of the memory tag 72 in accordance with the movement of the reading head 60H is additionally provided.

As illustrated in FIG. 16A, the cleaning member 66 is attached to, for example, the reading head 60H. The cleaning member 66 is formed from a material such as an unwoven fabric capable of catching moisture and oil. In addition, the cleaning member 66 is urged to protrude in a direction approaching the rotational axis of the rotary body 90 by an elastic member such as a spring or a sponge.

In the case of cleaning the tag contact 72a by the cleaning member 66, the motor M2 is activated in a state in which the rotary body 90 is in a posture in which the tag contact 72a opposes the cleaning member 66 as illustrated in FIG. 16A, and the driving rack 15 is moved in the first movement direction D15a. When the driving rack 15 engages with the reading pinion 61 as illustrated in FIG. 16B, the reading head 60H moves in an approaching direction D60a to move closer to the rotary body 90. Then, the cleaning member 66 comes into contact with the tag contact 72a, and thus the tag contact 72a is cleaned. To further reduce the soiling of the tag contact 72a, the reading head 60H may be reciprocated in a short stroke in a range in which the cleaning member 66 is in contact with the tag contact 72a.

By cleaning the tag contact 72a by the cleaning member 66, occurrence of a reading failure of the memory tag 72 can be suppressed even in the case where the toner cartridge 70 with a dirty tag contact 72a is attached.

The posture of the rotary body 90 when the tag contact 72a opposes the cleaning member 66 will be referred to as a cleaning posture. The cleaning posture may be a posture different from the reading posture and the replacement posture. In the case of reading the memory tag 72 after cleaning the tag contact 72a, the reading head 60H is retracted by the reverse rotation of the motor M2, the rotary body 90 is rotated from the cleaning posture to the reading posture, and then the reading head 60H is moved to the reading position by the normal rotation of the motor M2.

### Second Embodiment

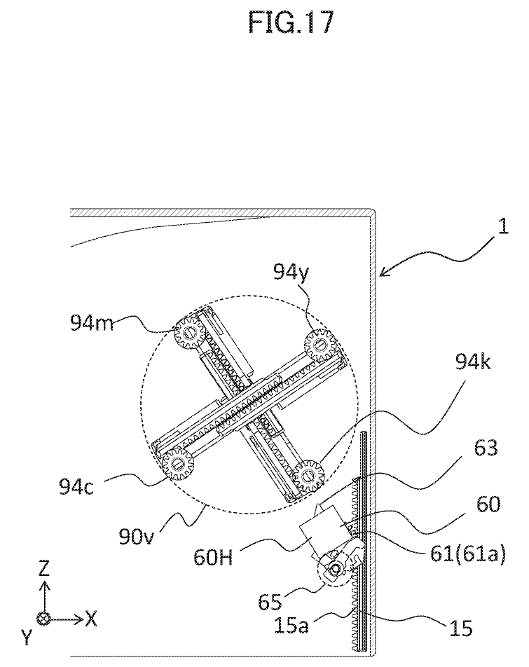

In the first embodiment, the fact that the driving rack 15 does not engage with the reading pinion 61 in the movement range of the driving rack 15 in replacement of the toner cartridge 70 has been described. However, there can be a case where engagement of the driving rack 15 with the reading pinion 61 in the movement range of the driving rack 15 in replacement of the toner cartridge 70 cannot be avoided due to the restriction by the casing size of the image forming apparatus 1 or the restriction in the element layout in the casing. For example, a case where the driving rack 15 engages with the reading pinion 61 in a state in which the driving rack 15 is at the lower position (same as FIG. 13A) that is a position before the start of the tray pull-out operation as illustrated in FIG. 17 due to the restriction in the element layout can be considered.

In such a case, in the present embodiment, inconvenience caused by collision between the reading head 60H and the rotary body 90 is avoided by providing a cancelling mechanism 65 serving as a blocking portion that blocks transmission of the driving force from the driving rack 15 to the reading head 60H. In the description below, it is assumed that elements denoted by the same reference signs as in the first embodiment have basically the same configurations and functions as those described in the first embodiment unless described otherwise, and part different from the first embodiment will be mainly described.

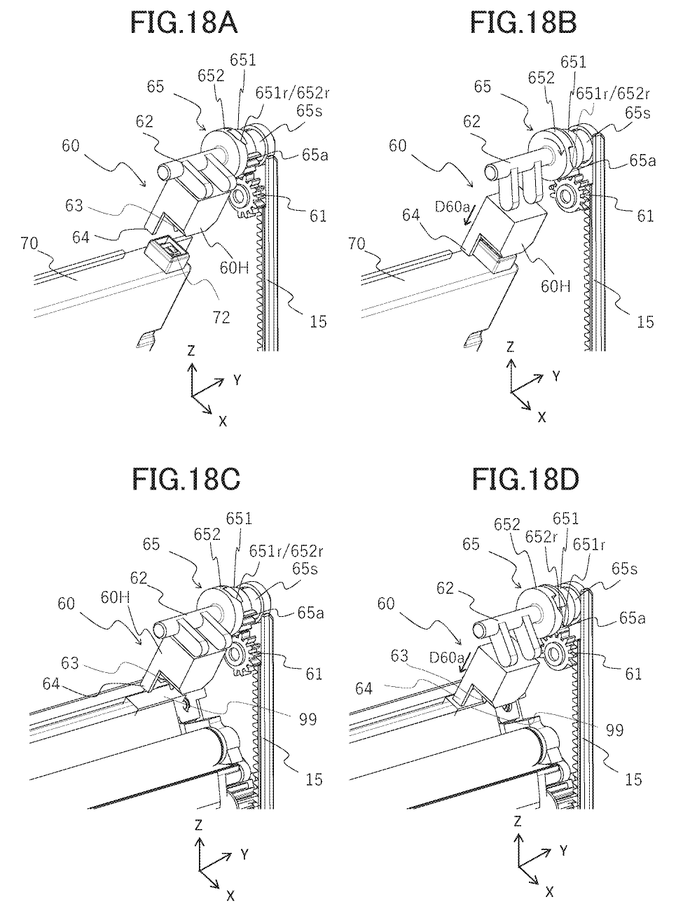

FIGS. 18A to 18D are each a diagram illustrating an example of the cancelling mechanism 65. To be noted, the position of the reading apparatus 60 in FIGS. 18A to 18D is different from that in FIG. 17, but the driving rack 15 still engages with the reading pinion 61 in the movement range of the driving rack 15 in replacement of the toner cartridge 70.

As illustrated in FIG. 18, the cancelling mechanism 65 includes an input-side rotary member 651 connected to the reading pinion 61, an output-side rotary member 652 connected to the head moving member 62, and a clutch spring 65s. In the illustrated example, the input-side rotary member 651 includes a gear portion 65a that engages with the reading pinion 61, and the output-side rotary member 652 is integrally formed with the head moving member 62 or fixed to the head moving member 62.

The input-side rotary member 651 and the output-side rotary member 652 respectively include inclined surfaces 651r and 652r that abut each other. The clutch spring 65s urges at least one of the input-side rotary member 651 and the output-side rotary member 652 so as to cause the inclined surfaces 651r and 652r to abut each other. In addition, in the case where a torque of a predetermined value or more acts between the input-side rotary member 651 and the output-side rotary member 652, the clutch spring 65s allows the input-side rotary member 651 and the output-side rotary member 652 to relatively rotate with respect to each other while the inclined surfaces 651r and 652r slide on each other. The cancelling mechanism 65 is a kind of a torque limiter of a spring type.

As illustrated in FIG. 18C, the rotary body 90 includes a regulating portion 99. In addition, the reading head 60H includes a regulated portion 64. The regulating portion 99 is disposed to oppose the regulated portion 64 of the reading apparatus 60 when the rotary body 90 is in the replacement posture. In addition, the regulated portion 64 is configured to protrude more than the reading contact 63 in the approaching direction D60a in which the reading head 60H moves toward the rotary body 90.

First, the operation of the cancelling mechanism 65 in reading of the memory tag 72 will be described. When the driving rack 15 moving in the first movement direction D15a engages with the reading pinion 61 as illustrated in FIG. 18A, the input-side rotary member 651 of the cancelling mechanism 65 engaged with the reading pinion 61 starts rotating in the clockwise direction in the drawings. Since the inclined surface 651r of the input-side rotary member 651 is pressed against the inclined surface 652r of the output-side rotary member 652 by the urging force of the clutch spring 65s, the output-side rotary member 652 receives a frictional force in the clockwise direction in the drawing from the input-side rotary member 651.

The load to rotate the output-side rotary member 652 in reading of the memory tag 72 is a force required for moving the reading head 60H mainly against the urging force of the urging member 67 (FIG. 13A), and is relatively small. Therefore, as illustrated in FIG. 18B, the output-side rotary member 652 rotates in the clockwise direction in the drawings together with the input-side rotary member 651. Further, as a result of the head moving member 62 rotating together with the output-side rotary member 652, the reading head 60H is moved from the retracted position to the reading position.

When reading the memory tag 72, the rotary body 90 is in the reading posture, and the regulating portion 99 of the rotary body 90 is at a position not opposing the regulated portion 64 of the reading apparatus 60. Therefore, the regulating portion 99 does not interrupt the movement of the reading head 60H from the retracted position to the reading position.

Next, the operation of the cancelling mechanism 65 in replacement of the toner cartridge 70 will be described. As illustrated in FIG. 18C, the driving rack 15 moving in the first movement direction D15a engages with the reading pinion 61 in the middle of the tray pull-out operation. That is, the driving rack 15 (driving member) engages with the reading pinion 61 (second force receiving portion) in the movement range of the driving rack 15 of the case where the tray 80 (support member) is moved from the accommodation position to the removal position.

When the driving rack 15 engages with the reading pinion 61, the input-side rotary member 651 of the cancelling mechanism 65 engaged with the reading pinion 61 starts rotating in the clockwise direction in the drawings. Similarly to when reading the memory tag 72, a force to rotate the output-side rotary member 652 together with the input-side rotary member 651 acts as a result of receiving a frictional force from the input-side rotary member 651.

Here, in replacement of the toner cartridge 70, the rotary body 90 is in the replacement posture, and the regulating portion 99 of the rotary body 90 is at a position opposing the regulated portion 64 of the reading apparatus 60. Therefore, when the reading head 60H moves toward the reading position in accordance with the rotation of the output-side rotary member 652, the regulated portion 64 abuts the regulating portion 99 (FIG. 18D). Then, the load to rotate the output-side rotary member 652 is increased by the reaction force that the regulated portion 64 receives from the regulating portion 99. When this load surpasses the frictional force generated at the contact surface between the inclined surfaces 651r and 652r by the urging force of the clutch spring 65s, slip occurs between the inclined surfaces 651r and 652r, and the input-side rotary member 651 and the output-side rotary member 652 relatively rotate with respect to each other. That is, while the input-side rotary member 651 rotates in an interlocked manner with the movement of the driving rack 15, the rotation of the output-side rotary member 652 is stopped.

As described above, the cancelling mechanism 65 (blocking portion) blocks transmission of the driving force from the reading pinion 61 to the reading head 60H (reading portion) in the case where the driving rack 15 (driving member) engages with the reading pinion 61 (second force receiving portion) in a state in which the rotary body 90 is in the replacement posture. In other words, when the rotary body 90 is in the replacement posture, the drive transmission from the driving rack 15 to the reading head 60H is blocked by the cancelling mechanism 65 (blocking portion). Therefore, the reading head 60H does not move to the reading position.

According to the present embodiment, breakage caused by collision between the reading head 60H and the rotary body 90, and the like can be suppressed even in a configuration in which the driving rack 15 engages with the reading pinion 61 in the movement range of the driving rack 15 in replacement of the toner cartridge 70.

The cancelling mechanism 65 described in the present embodiment is an example of a blocking portion, and a different mechanism capable of blocking the drive transmission may be used as a blocking portion. For example, the driving force may be transmitted by attracting force between magnets respectively attached to the input-side rotary member 651 and the output-side rotary member 652. In this case, when a load surpassing the attraction force between the magnets is applied to the output-side rotary member 652, the input-side rotary member 651 and the output-side rotary member 652 relatively rotate, and the movement of the reading head 60H stops.

### Modification Examples

To suppress breakage of the collision between the reading head 60H and the rotary body 90, means other than the blocking portion described in the second embodiment may be used. For example, a compression spring may be disposed between the head moving member 62 and the reading head 60H, and the head moving member 62 may press the reading head 60H via the compression spring. In this case, impact of the contact between the regulated portion 64 and the regulating portion 99 of the rotary body 90 is relieved by contraction of the compression spring, and thus breakage of the reading head 60H or the rotary body 90 can be suppressed.

In addition, as another means, a recess portion capable of receiving the reading head 60H may be provided in a portion of the rotary body 90 opposing the reading apparatus 60 when the rotary body 90 is in the replacement posture. The recess portion is a shape recessed more inward than a circle (virtual circle 90v indicated by a broken line in FIGS. 7A and 7B) circumscribing the rotary body 90 as viewed in the direction of the rotational axis of the rotary body 90. In this case, even if the reading head 60H is moved to the reading position in replacement of the toner cartridge 70, the reading head 60H is accommodated in the recess portion, and thus collision between the reading apparatus 60 and the rotary body 90 can be suppressed.

### Third Embodiment

As a third embodiment, an example in which the driving speed of the driving rack 15 is changed in the middle of the reading operation of the memory tag 72 will be described. In the description below, it is assumed that elements denoted by the same reference signs as in the first embodiment have basically the same configurations and functions as those described in the first embodiment unless described otherwise, and part different from the first embodiment will be mainly described.

As described in the first embodiment, in the reading operation of the memory tag 72, the driving rack 15 is moved from the lower position (FIG. 13A) to the upper position (FIG. 13B), and the driving rack 15 is moved from the upper position to the lower position after the information is read from the memory tag 72. In reciprocating movement like this, there is a section (idling section of the driving rack 15) where the driving rack 15 does not engage with the reading pinion 61.

That is, the movement range in which the driving rack 15 moves in the reading operation of the memory tag 72 includes an idling section in which the driving rack 15 does not engage with the reading pinion 61, and an engagement section in which the driving rack 15 engages with the reading pinion 61. The reading start operation described above is an operation performed when the driving rack 15 moves in the engagement section in the first movement direction D15a. The reading finish operation described above is an operation performed when the driving rack 15 moves in the engagement section in the second movement direction D15b.

In other words, in the case of reading information from the memory tag 72, the driving rack 15 (driving member) moves from the lower position (first position) of FIG. 13A to the upper position (third position) of FIG. 13B via an engagement start position (second position). The engagement start position is a position where the driving rack 15 moving in the first movement direction D15a from the lower position starts engaging with the reading pinion 61. The driving rack 15 does not engage with the reading pinion 61 serving as a force receiving portion of the movement mechanism (61, 62) that moves the reading head 60H in the section from the lower position to the engagement start position, and engages with the reading pinion 61 in the section from the engagement start position to the upper position.

Here, when the driving rack 15 moves in the engagement section, the motor M2 receives a load from the reading apparatus 60. In contrast, when the driving rack 15 moves in the idling section, the motor M2 does not receive a load from the reading apparatus 60.

Therefore, in the present embodiment, the driving speed of the driving rack 15 in the idling period of the driving rack 15 is set to a value higher than the driving speed of the driving rack 15 in the reading start operation and the reading finish operation.

In other words, in the case where reading of information from the memory tag 72 (storage portion) is performed, the driving speed of the driving rack 15 (driving member) while the driving rack 15 (driving member) moves in the section (idling section) from the lower position (first position) to the engagement start position (second position) will be referred to as a third driving speed. In addition, similarly to the first embodiment, the driving speed of the driving rack 15 (driving member) when the toner cartridge 70 moves from the attached position to the retracted position (detachment position) will be referred to as a second driving speed. In this case, the third driving speed is higher than the second driving speed.

As a result of this, the reading operation of the memory tag 72 can be completed in a shorter time, and thus the waiting time for the user can be shortened further. That is, according to the present embodiment, the usability can be further improved.

### Fourth Embodiment

In the first and third embodiments, an example in which the second driving speed is set to be higher than the first driving speed has been described. In other words, an example in which the driving speed of the driving rack 15 in reading of the memory tag 72 is higher than the driving speed of the driving rack 15 in replacement of the toner cartridge 70 has been described.

In the fourth embodiment, the second driving speed is set to be lower than the first driving speed. In the present embodiment, the driving speed of the driving rack 15 in replacement of the toner cartridge 70 is lower than the driving speed of the driving rack 15 in reading of the memory tag 72.

For example, a case where the movement speed of the driving rack 15 in replacement of the toner cartridge 70 is high and the driving speed of the driving rack 15 in reading of the memory tag 72 is set higher is assumed. In this case, the speed of the collision between the reading contact 63 and the tag contact 72a becomes high, and thus there is a possibility that the wear of the contacts is accelerated. In such a case, the wear of the contacts can be reduced by setting the driving speed (second driving speed) of the driving rack 15 in reading of the memory tag 72 to be lower than the driving speed (first driving speed) of the driving rack 15 in replacement of the toner cartridge 70.

To be noted, the present embodiment and the third embodiment may be combined. That is, the driving speed of the driving rack 15 (driving member) while the driving rack 15 moves in the idling section from the lower position to the engagement start position may be set to be higher than the driving speed (first driving speed of the driving rack 15 in replacement of the toner cartridge 70. In addition, the driving speed (second driving speed) of the driving rack 15 (driving member) while the driving rack 15 moves in the engagement section from the engagement start position to the upper position may be set to be lower than the driving speed (first driving speed of the driving rack 15 in replacement of the toner cartridge 70.

As a result of this, shortening the waiting time for the user and reducing the wear of contacts can be achieved simultaneously.

### Other Modification Examples

A configuration in which the pinion gear 94 (first force receiving portion) of the rotary body 90 is connected to the tray 80 (support member) and the tray moving operation is performed by drive transmission from the driving rack 15 (driving member) to the pinion gear 94 has been described in the embodiments described above. The configuration is not limited to this, and the pinion gear 94 (first force receiving portion) of the rotary body 90 may be connected to an element other than the tray 80 in the rotary body 90. For example, the pinion gear 94 may be directly connected to the developing unit 50, and at least part of the developing unit 50 may be driven by the drive transmission from the driving rack 15 (driving member) to the pinion gear 94.

The toner cartridge 70 is an example of a cartridge attachable to and detachable from the rotary body 90, and a cartridge having a different configuration may be attached to and detached from the rotary body 90. For example, the developing unit 50 may be configured as a cartridge attachable to and detachable from the rotary frame 90f serving as the rotary body 90.

The memory tag 72 that is a semiconductor memory (storage device constituted by a semiconductor element) has been described as an example of a storage portion provided in the cartridge in the embodiments described above. The storage portion is not limited to this, and may be, for example, an image containing information such as a two-dimensional barcode. In this case, the reading portion may be a reading apparatus (image sensor) that optically reads an image. In addition, the storage portion may be a resistor element. In this case, the reading portion may be an electric circuit capable of detecting the resistance value of the resistor element. In addition, the controller 30 can identify, for example, the color of the toner stored in the toner cartridge 70 on the basis of the detected resistance value.

The method for the reading portion to read information from the storage portion is not limited to the contact communication via the contact between contacts, and may be, for example, contactless communication (wireless communication). An example of the contactless communication is communication performed between a radio frequency identification (RFID) tag serving as a storage portion and an RFID reader serving as a reading portion.

Although the image forming apparatus 1 of a rotary development system has been described as an example in the embodiments described above, the technique of the present disclosure may be applied to an image forming apparatus other than a rotary development system. That is, the “cartridge” is not limited to one attached to or detached from a rotary (rotary body 90) of a rotary development system.

According to the present disclosure, a new form of an image forming apparatus that advances conventional technology can be provided

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-020949, filed February 12, 2025, and Japanese Patent Application No. 2025-020950, filed February 12, 2025, all of which are hereby incorporated by reference herein in their entirety.

What is claimed is:

1. An image forming apparatus to which a cartridge including a storage portion is to be detachably attached, the storage portion being configured to store information, the image forming apparatus comprising:
a rotary to which the cartridge is to be detachably attached, the rotary configured to rotate and including a first force receiving portion; and
a main body accommodating the rotary and including a reading portion, a controller configured to read the information from the storage portion via the reading portion, a second force receiving portion connected to the reading portion, and a driving member configured to transmit a driving force,
wherein the reading portion is movable between a reading position and a retracted position retracted from the reading position with respect to the rotary and configured such that the controller reads the information in a state in which the reading portion is at the reading position,
wherein the first force receiving portion is configured to receive the driving force such that the driving force is transmitted to the rotary via the first force receiving portion in a state in which the driving member is engaged with the first force receiving portion, and
wherein the second force receiving portion is configured to receive the driving force such that the driving force is transmitted to the reading portion via the second force receiving portion in a state in which the driving member is engaged with the second force receiving portion, such that the reading portion is moved between the reading position and the retracted position.

2. The image forming apparatus according to claim 1,
wherein the rotary is rotatable to a replacement posture where attachment and detachment of the cartridge are allowed and a reading posture where reading of the information from the storage portion via the reading portion is to be performed,
wherein the first force receiving portion is configured to be located at a position where the first force receiving portion is engageable with the driving member in a case where the rotary is in the replacement posture, and
wherein the first force receiving portion is configured to be located at a position where the first force receiving portion does not engage with the driving member in a case where the rotary is in the reading posture.

3. The image forming apparatus according to claim 2,
wherein the driving member includes a plurality of teeth arranged in an intersecting direction intersecting with a direction of a rotational axis of the rotary and is configured to reciprocate in the intersecting direction,
wherein the first force receiving portion is a gear rotatable and engageable with the plurality of teeth, and
wherein, as viewed in the direction of the rotational axis in a state in which the rotary is in the reading posture, the gear is at a position where the gear does not overlap with a movement trajectory of the plurality of teeth of the driving member moving in the intersecting direction.

4. The image forming apparatus according to claim 1,
wherein the first force receiving portion is configured to receive the driving force such that the cartridge moves with respect to the rotary in a state in which the driving member is engaged with the first force receiving portion.

5. The image forming apparatus according to claim 4, further comprising:
a support member attached to the rotary and configured to support the cartridge,
wherein the support member is configured to be moved between an accommodation position where the cartridge is accommodated in the rotary and a removal position where the cartridge protrudes to an outside of the rotary, by the driving force transmitted from the driving member to the first force receiving portion.

6. The image forming apparatus according to claim 5,
wherein the driving member is configured (i) to not engage with the second force receiving portion in a movement range of the driving member in a case where the support member moves from the accommodation position to the removal position, and (ii) engage with the second force receiving portion at a position outside the movement range.

7. The image forming apparatus according to claim 6,
wherein the driving member is configured to move from a first position to a second position in a case where the support member is moved from the accommodation position to the removal position,
wherein the driving member is configured to move to a third position, which is downstream of the second position in a movement direction from the first position toward the second position, in a case where the reading portion is moved from the retracted position to the reading position, and
wherein a position, where the driving member moving in the movement direction starts engaging with the second force receiving portion, is downstream of the second position in the movement direction.

8. The image forming apparatus according to claim 5,
wherein the driving member is configured to engage with the second force receiving portion in a movement range of the driving member in a case of moving the support member from the accommodation position to the removal position,
wherein the rotary is rotatable to (i) a replacement posture in which attachment and detachment of the cartridge are allowed, and (ii) a reading posture in which the information is read from the storage portion, and
wherein the image forming apparatus further comprises a blocking portion configured to block transmission of the driving force from the second force receiving portion to the reading portion in a case where the driving member is engaged with the second force receiving portion in a state in which the rotary is in the replacement posture.

9. The image forming apparatus according to claim 1, further comprising:
a moving member including a pressing portion configured to press the reading portion, the moving member being configured to move the reading portion by receiving the driving force via the second force receiving portion,
wherein the second force receiving portion includes an engaged portion configured to be engaged with the driving member, and
wherein in a case where the reading portion is moved by the driving force, a movement amount of the pressing portion is larger than a movement amount of the engaged portion.

10. The image forming apparatus according to claim 1,
wherein, in a case that the cartridge and the storage portion are defined as a first cartridge and a first storage portion, the rotary is a rotary to which the first cartridge and a second cartridge including a second storage portion are detachably attached, and
wherein the controller is configured to read information from the second storage portion via the reading portion.

11. The image forming apparatus according to claim 1,
wherein the storage portion includes a first contact, and
wherein the reading portion includes a second contact configured to come into contact with the first contact in a case where the reading portion is at the reading position.

12. The image forming apparatus according to claim 11,
wherein the storage portion and the controller are configured to be electrically connected to each other via the contact between the first contact and the second contact.

13. The image forming apparatus according to claim 11,
wherein in a case where the reading portion is at the retracted position, the second contact is positioned outside a virtual circle circumscribing the rotary as viewed in a direction of a rotational axis of the rotary, and
wherein in a case where the reading portion is at the reading position, at least part of the second contact is positioned inside the virtual circle as viewed in the direction of the rotational axis.

14. The image forming apparatus according to claim 1,
wherein the rotary includes
a developing roller, and
a storage frame including a toner storage portion configured to store toner to be supplied to the developing roller, and
wherein the cartridge is configured to store toner to replenish the toner storage portion.

15. An image forming apparatus to which a cartridge including a storage portion is detachably attached, the storage portion being configured to store information, the image forming apparatus comprising:
a main body to which the cartridge is detachably attached, the main body including a drive source, a driving member configured to be moved by a driving force of the drive source, a reading portion, and a controller configured to read the information from the storage portion via the reading portion,
wherein the cartridge is configured to be moved between an attached position where the cartridge is attached to the main body and a detachment position where detachment of the cartridge from the main body is allowed, by the driving force transmitted via the driving member,
wherein the reading portion is configured to be moved between a reading position and a retracted position retracted from the reading position by the driving force transmitted via the driving member, and configured such that the controller reads the information in a state in which the reading portion is at the reading position, and
wherein a first driving speed, that is a driving speed of the driving member in a case where the cartridge is moved from the attached position to the detachment position, is different from a second driving speed, that is a driving speed of the driving member in a case where the reading portion is moved from the retracted position to the reading position.

16. The image forming apparatus according to claim 15,
wherein the second driving speed is higher than the first driving speed.

17. The image forming apparatus according to claim 16,
wherein the main body includes a movement mechanism configured to move the reading portion and including a force receiving portion configured to receive the driving force from the driving member,
wherein the driving member is configured to:
move from a first position to a third position via a second position in a case where the information is read via the reading portion; and
in moving from the first position to the third position, not engage with the force receiving portion in a section from the first position to the second position and engage with the force receiving portion in a section from the second position to the third position, and
wherein in a case where the information is read from the storage portion, a driving speed of the driving member while the driving member moves in the section from the first position to the second position is higher than the second driving speed.

18. The image forming apparatus according to claim 15, further comprising:
a rotary configured to rotate and be accommodated in the main body,
wherein the cartridge is attachable to and detachable from the rotary, and
wherein the rotary includes
a developing roller, and
a storage frame including a toner storage portion configured to store toner supplied to the developing roller, and the cartridge is configured to store toner to replenish the toner storage portion.

19. The image forming apparatus according to claim 15,
wherein when the cartridge and the storage portion are defined as a first cartridge and a first storage portion, the main body is a main body to which the first cartridge and a second cartridge including a second storage portion are detachably attached, and
wherein the controller is configured to read information from the second storage portion via the reading portion.

20. The image forming apparatus according to claim 15,
wherein the storage portion includes a first contact,
wherein the reading portion includes a second contact configured to come into contact with the first contact in a case where the reading portion is at the reading position, and
wherein the storage portion and the controller are configured to be electrically connected to each other via the contact between the first contact and the second contact.
